(19) United States
(12) Patent Application Publication
(10) Pub. No.: US 2024/0300115 A1
(43) Pub. Date: Sep. 12, 2024

(54) SYSTEMS, METHODS, AND CONTROL MODULES FOR CONTROLLING STATES OF ROBOT SYSTEMS

(71) Applicant: Sanctuary Cognitive Systems Corporation, Vancouver (CA)

(72) Inventors: Geordie Rose, Vancouver (CA); Suzanne Gildert, Vancouver (CA)

(21) Appl. No.: 18/598,038

(22) Filed: Mar. 7, 2024

Related U.S. Application Data
(60) Provisional application No. 63/450,460, filed on Mar. 7, 2023.

(51) Int. Cl. B25J 13/08; B25J 9/16

(52) U.S. Cl. CPC B25J 13/089; B25J 9/163; B25J 9/1664; B25J 9/1697; B25J 13/084

(57) ABSTRACT

Systems, methods, and control modules for controlling robot systems are described. A state of a robot body is identified based on environment and context data, and a state prediction model is applied to predict subsequent states of the robot body. The robot body is controlled to transition to predicted states. Transitions to states can be validated, and predicted states updated when transitioning of the robot body is not aligned with predicted states.

### TECHNICAL FIELD

The present systems, methods and control modules generally relate to controlling robot systems, and in particular relate to controlling states of robot systems.

### DESCRIPTION OF THE RELATED ART

Robots are machines that may be deployed to perform work. General purpose robots (GPRs) can be deployed in a variety of different environments, to achieve a variety of objectives or perform a variety of tasks. Robots can engage, interact with, and manipulate objects in a physical environment. It is desirable for a robot to use sensor data to predict, control, and optimize movement of the robot within an environment.

### BRIEF SUMMARY

According to a broad aspect, the present disclosure describes a robot system comprising: a robot body; at least one environment sensor carried by the robot body; at least one robot body sensor carried by the robot body; a robot controller which includes at least one processor and at least one non-transitory processor-readable storage medium communicatively coupled to the at least one processor, the at least one processor-readable storage medium storing processor-executable instructions which when executed by the at least one processor cause the robot system to: capture, by the at least one environment sensor, first environment data representing an environment of the robot body at a first time; capture, by the at least one robot body sensor, first robot body data representing a configuration of the robot body at the first time; access context data indicating a context for operation of the robot system; determine a first state of the robot body within the environment for the first time, based on the first environment data and the first robot body data; apply a state prediction model to predict a predicted second state of the robot body within the environment for a second time subsequent the first time, wherein the state prediction model accounts for the first state of the robot body within the environment and the context for operation of the robot system as indicated in the context data; and control the robot body to transition towards the predicted second state from the first state.

The processor-executable instructions may further cause the robot system to, at or after the second time: capture, by the at least one environment sensor, second environment data representing an environment of the robot body at the second time; capture, by the at least one robot body sensor, second robot body data representing a configuration of the robot body at the second time; determine an actual second state of the robot body within the environment for the second time, based on the second environment data and the second robot body data; and determine whether the actual second state matches the predicted second state of the robot body. The processor-executable instructions may further cause the robot system to: before the second time: apply the state prediction model to predict a predicted third state of the robot body within the environment for a third time subsequent the second time, wherein the state prediction model accounts for the predicted second state of the robot body within the environment and the context for operation of the robot system as indicated in the context data; and at or after the second time: if the actual second state is determined as not matching the predicted second state, apply the state prediction model to update the predicted third state of the robot body within the environment for the third time subsequent the second time, wherein the state prediction model accounts for the actual second state of the robot body within the environment and the context for operation of the robot system as indicated in the context data; and control the robot body to transition towards the predicted third state from the actual second state.

The processor-executable instructions which cause the robot system to apply the state prediction model to predict a predicted second state may cause the robot system to: apply the state prediction model to predict a sequence of states for the robot body within the environment for a sequence of times subsequent the first time, wherein the state prediction model accounts for the first state of the robot body within the environment and the context for operation of the robot system as indicated in the context data, and wherein each state in the sequence of states is predicted based on an immediately prior state in the sequence of states, and where the second state is predicted as one state in the sequence of states. The processor-executable instructions which cause the robot system to control the robot body to transition towards the predicted second state from the first state may cause the robot system to control the robot body to transition through the sequence of states including the second state. The processor-executable instructions which cause the robot system to control the robot body to transition through the sequence of states may cause the robot system to, for at least one state transitioned to: capture, by the at least one environment sensor, respective environment data representing an environment of the robot body at a respective time of the state transitioned to; capture, by the at least one robot body sensor, respective robot body data representing a configuration of the robot body at the respective time of the state transitioned to; determine an actual state of the robot body within the environment for the respective time of the state transitioned to, based on the respective environment data and the respective robot body data; and determine whether the actual state matches a predicted state of the robot body for the respective time of the state transitioned to, as predicted during the prediction of the sequence of states. The processor-executable instructions which cause the robot system to control the robot body to transition through the sequence of states may cause the robot system to, for the at least one state transitioned to: if the actual state is determined to match a predicted state for the respective time of the state transitioned to: continue to control the robot system to transition through the sequence of states; and if the actual state is determined to not match a predicted state for the respective time of the state transitioned to: apply the state prediction model to update the sequence of states of the robot body within the environment for an updated sequence of times subsequent the respective time of the state transitioned to, wherein the state prediction model accounts for the actual state of the robot body within the environment at the respective time and the context for operation of the robot system as indicated in the context data, and wherein each updated state in the sequence of states is predicted based on an immediately prior state in the sequence of states; and control the robot body to transition through the updated sequence of states.

The context data may indicate an action the robot system is to perform or is performing. The context data may indicate a task to which the robot system is directed. The context data may include labels indicating instruction sets which are available for the robot controller to execute.

The at least one non-transitory processor-readable storage medium may store a library of instruction sets; the context data may include a respective binary label for each instruction set in the library of instruction sets, each binary label indicating whether a respective instruction set in the library of instruction sets is available for execution by the robot controller.

The at least one environment sensor may include one or more environment sensors selected from a group of sensors consisting of: an image sensor operable to capture image data; an audio sensor operable to capture audio data; and a tactile sensor operable to capture tactile data.

The at least one robot body sensor may include one or more robot body sensors selected from a group of sensors consisting of: a haptic sensor which captures haptic data; an actuator sensor which captures actuator data indicating a state of a corresponding actuator; a battery sensor which captures battery data indicating a state of a battery; an inertial sensor which captures inertial data; a proprioceptive sensor which captures proprioceptive data indicating a position, movement, or force applied for a corresponding actuatable member of the robot body; and a position encoder which captures position data about at least one joint or appendage of the robot body.

The second state may be subsequent the first state by a time difference of less than one second.

The robot controller may be carried by the robot body. The processor-executable instructions which cause the robot system to access the context data may cause the robot system to: receive the context data from a remote device remote from the robot body. The processor-executable instructions which cause the robot system to access the context data may cause the robot system to: retrieve the context data from the at least one non-transitory processor-readable storage medium of the robot controller.

The robot controller may be positioned remote from the robot body.

According to another broad aspect, the present disclosure describes a method for operating a robot system including a robot controller and a robot body, the method comprising: capturing, by at least one environment sensor carried by the robot body, first environment data representing an environment of the robot body at a first time; capturing, by at least one robot body sensor carried by the robot body, first robot body data representing a configuration of the robot body at the first time; accessing, by the robot controller, context data indicating a context for operation of the robot system; determining, by the robot controller, a first state of the robot body within the environment for the first time, based on the first environment data and the first robot body data; applying, by the robot controller, a state prediction model to predict a predicted second state of the robot body within the environment for a second time subsequent the first time, wherein the state prediction model accounts for the first state of the robot body within the environment and the context for operation of the robot system as indicated in the context data; and controlling, by the robot controller, the robot body to transition towards the predicted second state from the first state.

The method may further comprise, at or after the second time: capturing, by the at least one environment sensor, second environment data representing an environment of the robot body at the second time; capturing, by the at least one robot body sensor, second robot body data representing a configuration of the robot body at the second time; determining, by the robot controller, an actual second state of the robot body within the environment for the second time, based on the second environment data and the second robot body data; and determining, by the robot controller, whether the actual second state matches the predicted second state of the robot body. The method may further comprise: before the second time: applying the state prediction model to predict a predicted third state of the robot body within the environment for a third time subsequent the second time, wherein the state prediction model accounts for the predicted second state of the robot body within the environment and the context for operation of the robot system as indicated in the context data; and at or after the second time: if the actual second state is determined as not matching the predicted second state, applying the state prediction model to update the predicted third state of the robot body within the environment for the third time subsequent the second time, wherein the state prediction model accounts for the actual second state of the robot body within the environment and the context for operation of the robot system as indicated in the context data; and controlling the robot body to transition towards the predicted third state from the actual second state.

Applying the state prediction model to predict a predicted second state may comprise: applying the state prediction model to predict a sequence of states for the robot body within the environment for a sequence of times subsequent the first time, wherein the state prediction model accounts for the first state of the robot body within the environment and the context for operation of the robot system as indicated in the context data, and wherein each state in the sequence of states is predicted based on an immediately prior state in the sequence of states, and where the second state is predicted as one state in the sequence of states. Controlling the robot body to transition towards the predicted second state from the first state may comprise controlling the robot body to transition through the sequence of states including the second state. Controlling the robot body to transition through the sequence of states may comprise, for at least one state transitioned to: capturing, by the at least one environment sensor, respective environment data representing an environment of the robot body at a respective time of the state transitioned to; capturing, by the at least one robot body sensor, respective robot body data representing a configuration of the robot body at the respective time of the state transitioned to; determining an actual state of the robot body within the environment for the respective time of the state transitioned to, based on the respective environment data and the respective robot body data; and determining whether the actual state matches a predicted state of the robot body for the respective time of the state transitioned to, as predicted during the prediction of the sequence of states. Controlling the robot body to transition through the sequence of states may comprise, for the at least one state transitioned to: if the actual state is determined to match a predicted state for the respective time of the state transitioned to: continue controlling the robot system to transition through the sequence of states; and if the actual state is determined to not match a predicted state for the respective time of the state transitioned to: apply the state prediction model to update the sequence of states of the robot body within the environment for an updated sequence of times subsequent the respective time of the state transitioned to, wherein the state prediction model accounts for the actual state of the robot body within the environment at the respective time and the context for operation of the robot system as indicated in the context data, and wherein each updated state in the sequence of states is predicted based on an immediately prior state in the sequence of states; and controlling the robot body to transition through the updated sequence of states.

The context data may indicate an action the robot system is to perform or is performing. The context data may indicate a task to which the robot system is directed. The context data may include labels indicating instruction sets which are available for the robot controller to execute.

At least one non-transitory processor-readable storage medium of the robot system may store a library of instruction sets; the context data may include a respective binary label for each instruction set in the library of instruction sets, each binary label indicating whether a respective instruction set in the library of instruction sets is available for execution by the robot controller.

Capturing, by the at least one environment sensor carried by the robot body, the first environment data may comprise capturing environment data selected from a group of data consisting of: image data from an image sensor; audio data from an audio sensor; and tactile data from a tactile sensor.

Capturing, by the at least one robot body sensor carried by the robot body, the first robot body data may comprise capturing robot body data selected from a group of data consisting of: haptic data from a haptic sensor; actuator data indicating a state of a corresponding actuator from an actuator sensor; battery data indicating a state of a battery from a battery sensor; inertial data from an inertial sensor; proprioceptive data indicating a position, movement, or force applied for a corresponding actuatable member of the robot body from a proprioceptive sensor; and position data about at least one joint or appendage of the robot body from a position encoder.

The second state may be subsequent the first state by a time difference of less than one second.

Accessing the context data, determining the first state, applying the state prediction model, and controlling the robot body, as performed by the robot controller, may be performed by the robot controller as carried by the robot body. Accessing the context data may comprise receiving the context data from a remote device remote from the robot body. Accessing the context data may comprise retrieving the context data from at least one non-transitory processor-readable storage medium of the robot controller.

Accessing the context data, determining the first state, applying the state prediction model, and controlling the robot body, as performed by the robot controller, may be performed by the robot controller as positioned remote from the robot body.

According to yet another broad aspect, the present disclosure describes a robot control module comprising at least one non-transitory processor-readable storage medium storing processor-executable instructions or data that, when executed by at least one processor of a processor-based system, cause the processor-based system to: capture, by at least one environment sensor carried by a robot body of the processor-based system, first environment data representing an environment of the robot body at a first time; capture, by at least one robot body sensor carried by the robot body, first robot body data representing a configuration of the robot body at the first time; access context data indicating a context for operation of the processor-based system; determine a first state of the robot body within the environment for the first time, based on the first environment data and the first robot body data; apply a state prediction model to predict a predicted second state of the robot body within the environment for a second time subsequent the first time, wherein the state prediction model accounts for the first state of the robot body within the environment and the context for operation of the robot system as indicated in the context data; and control the robot body to transition towards the predicted second state from the first state.

The processor-executable instructions may further cause the processor-based system to, at or after the second time: capture, by the at least one environment sensor, second environment data representing an environment of the robot body at the second time; capture, by the at least one robot body sensor, second robot body data representing a configuration of the robot body at the second time; determine an actual second state of the robot body within the environment for the second time, based on the second environment data and the second robot body data; and determine whether the actual second state matches the predicted second state of the robot body. The processor-executable instructions may further cause the processor-based system to: before the second time: apply the state prediction model to predict a predicted third state of the robot body within the environment for a third time subsequent the second time, wherein the state prediction model accounts for the predicted second state of the robot body within the environment and the context for operation of the robot system as indicated in the context data; and at or after the second time: if the actual second state is determined as not matching the predicted second state, apply the state prediction model to update the predicted third state of the robot body within the environment for the third time subsequent the second time, wherein the state prediction model accounts for the actual second state of the robot body within the environment and the context for operation of the robot system as indicated in the context data; and control the robot body to transition towards the predicted third state from the actual second state.

The processor-executable instructions which cause the processor-based system to apply the state prediction model to predict a predicted second state may cause the processor-based system to: apply the state prediction model to predict a sequence of states for the robot body within the environment for a sequence of times subsequent the first time, wherein the state prediction model accounts for the first state of the robot body within the environment and the context for operation of the processor-based system as indicated in the context data, and wherein each state in the sequence of states is predicted based on an immediately prior state in the sequence of states, and where the second state is predicted as one state in the sequence of states. The processor-executable instructions which cause the processor-based system to control the robot body to transition towards the predicted second state from the first state may cause the processor-based system to control the robot body to transition through the sequence of states including the second state. The processor-executable instructions which cause the processor-based system to control the robot body to transition through the sequence of states may cause the processor-based system to, for at least one state transitioned to: capture, by the at least one environment sensor, respective environment data representing an environment of the robot body at a respective time of the state transitioned to; capture, by the at least one robot body sensor, respective robot body data representing a configuration of the robot body at the respective time of the state transitioned to; determine an actual state of the robot body within the environment for the respective time of the state transitioned to, based on the respective environment data and the respective robot body data; and determine whether the actual state matches a predicted state of the robot body for the respective time of the state transitioned to, as predicted during the prediction of the sequence of states. The processor-executable instructions which cause the processor-based system to control the robot body to transition through the sequence of states may cause the processor-based system to, for the at least one state transitioned to: if the actual state is determined to match a predicted state for the respective time of the state transitioned to: continue to control the processor-based system to transition through the sequence of states; and if the actual state is determined to not match a predicted state for the respective time of the state transitioned to: apply the state prediction model to update the sequence of states of the robot body within the environment for an updated sequence of times subsequent the respective time of the state transitioned to, wherein the state prediction model accounts for the actual state of the robot body within the environment at the respective time and the context for operation of the processor-based system as indicated in the context data, and wherein each updated state in the sequence of states is predicted based on an immediately prior state in the sequence of states; and control the robot body to transition through the updated sequence of states.

The context data may indicate an action the processor-based system is to perform or is performing. The context data may indicate a task to which the processor-based system is directed. The context data may include labels indicating instruction sets which are available for the robot controller to execute.

The at least one non-transitory processor-readable storage medium may store a library of instruction sets; the context data may include a respective binary label for each instruction set in the library of instruction sets, each binary label indicating whether a respective instruction set in the library of instruction sets is available for execution by the robot controller.

The at least one environment sensor may include one or more environment sensors selected from a group of sensors consisting of: an image sensor operable to capture image data; an audio sensor operable to capture audio data; and a tactile sensor operable to capture tactile data.

The at least one robot body sensor may include one or more robot body sensors selected from a group of sensors consisting of: a haptic sensor which captures haptic data; an actuator sensor which captures actuator data indicating a state of a corresponding actuator; a battery sensor which captures battery data indicating a state of a battery; an inertial sensor which captures inertial data; a proprioceptive sensor which captures proprioceptive data indicating a position, movement, or force applied for a corresponding actuatable member of the robot body; and a position encoder which captures position data about at least one joint or appendage of the robot body.

The second state may be subsequent the first state by a time difference of less than one second.

The at least one non-transitory processor-readable storage medium and the at least one processor may be carried by the robot body. The processor-executable instructions which cause the processor-based system to access the context data may cause the processor-based system to: receive the context data from a remote device remote from the robot body. The processor-executable instructions which cause the processor-based system to access the context data may cause the processor-based system to: retrieve the context data from the at least one non-transitory processor-readable storage medium of the robot control module.

The at least one non-transitory processor-readable storage medium and the at least one processor may be positioned remote from the robot body.

### BRIEF DESCRIPTION OF THE SEVERAL VIEWS OF THE DRAWINGS

The various elements and acts depicted in the drawings are provided for illustrative purposes to support the detailed description. Unless the specific context requires otherwise, the sizes, shapes, and relative positions of the illustrated elements and acts are not necessarily shown to scale and are not necessarily intended to convey any information or limitation. In general, identical reference numbers are used to identify similar elements or acts.

FIG. 1 is an illustrative diagram of an exemplary robot system comprising various features and components described throughout the present systems, methods, and control modules.

FIG. 2 is an illustrative diagram of another exemplary robot system comprising various features and components described throughout the present systems, methods, and control modules.

FIG. 3 is an illustrative diagram of yet another exemplary robot system comprising various features and components described throughout the present systems, methods, and control modules.

FIG. 4 is a flowchart diagram which illustrates a method of operating a robot system, in accordance with one exemplary illustrated implementation.

FIG. 5 is a partial side view which illustrates an exemplary first state of a robot body.

FIG. 6 is a partial side view which illustrates an exemplary second state of a robot body.

FIG. 7 is a partial side view which illustrates an exemplary third state of a robot body.

FIG. 8 is a partial side view which illustrates an exemplary actual state of a robot body which does not match a predicted state.

FIG. 9 is a partial side view which illustrates an exemplary updated state of a robot body.

FIG. 10 is a partial side view which illustrates an exemplary fourth state of a robot body.

FIG. 11 is a partial side view which illustrates an exemplary fifth state of a robot body.

FIG. 12 is a flowchart diagram which illustrates a method of operating a robot system, in accordance with another exemplary illustrated implementation.

FIG. 13 is a partial side view which illustrates an exemplary sixth state of a robot body.

FIG. 14 is a matrix representing an exemplary form of state prediction model.

FIG. 15 is another matrix representing an exemplary form of state prediction model.

FIG. 16 is yet another matrix representing an exemplary form of state prediction model.

### DETAILED DESCRIPTION

The following description sets forth specific details in order to illustrate and provide an understanding of the various implementations and embodiments of the present systems, methods, and control modules. A person of skill in the art will appreciate that some of the specific details described herein may be omitted or modified in alternative implementations and embodiments, and that the various implementations and embodiments described herein may be combined with each other and/or with other methods, components, materials, etc. in order to produce further implementations and embodiments.

In some instances, well-known structures and/or processes associated with computer systems and data processing have not been shown or provided in detail in order to avoid unnecessarily complicating or obscuring the descriptions of the implementations and embodiments.

Unless the specific context requires otherwise, throughout this specification and the appended claims the term “comprise” and variations thereof, such as “comprises” and “comprising,” are used in an open, inclusive sense to mean “including, but not limited to.”

Unless the specific context requires otherwise, throughout this specification and the appended claims the singular forms “a,” “an,” and “the” include plural referents. For example, reference to “an embodiment” and “the embodiment” include “embodiments” and “the embodiments,” respectively, and reference to “an implementation” and “the implementation” include “implementations” and “the implementations,” respectively. Similarly, the term “or” is generally employed in its broadest sense to mean “and/or” unless the specific context clearly dictates otherwise.

The headings and Abstract of the Disclosure are provided for convenience only and are not intended, and should not be construed, to interpret the scope or meaning of the present systems, methods, and control modules.

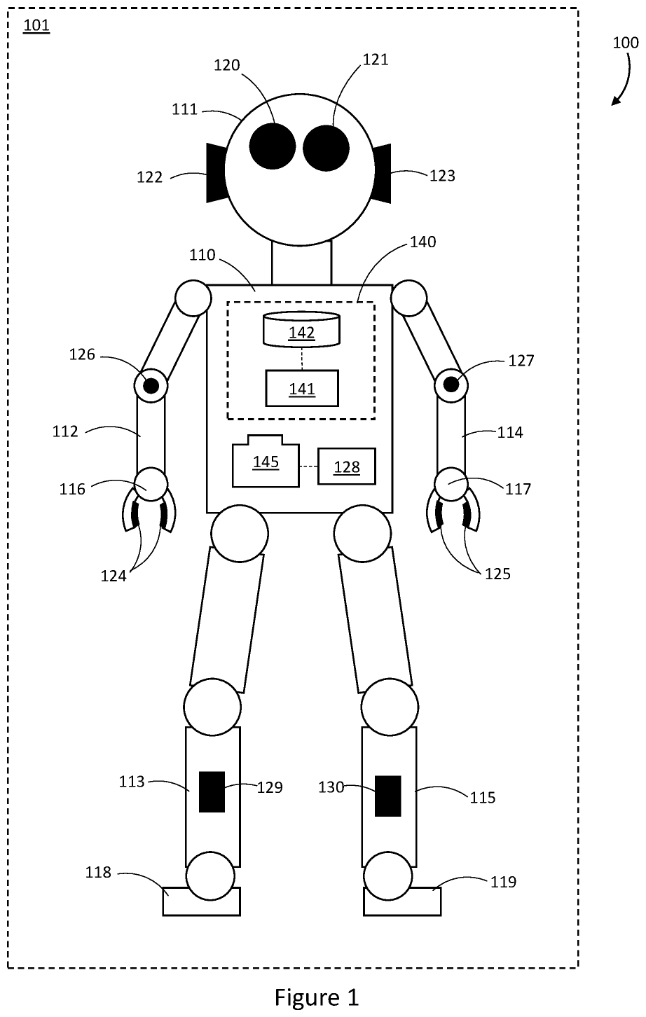

FIG. 1 is a front view of an exemplary robot system 100 in accordance with one implementation. In the illustrated example, robot system 100 includes a robot body 101 that is designed to approximate human anatomy, including a torso 110 coupled to a plurality of components including head 111, right arm 112, right leg 113, left arm 114, left leg 115, right end-effector 116, left end-effector 117, right foot 118, and left foot 119, which approximate anatomical features. More or fewer anatomical features could be included as appropriate for a given application. Further, how closely a robot approximates human anatomy can also be selected as appropriate for a given application.

Each of components 110, 111, 112, 113, 114, 115, 116, 117, 118, and 119 can be actuatable relative to other components. Any of these components which is actuatable relative to other components can be called an actuatable member. Actuators, motors, or other movement devices can couple together actuatable components. Driving said actuators, motors, or other movement driving mechanism causes actuation of the actuatable components. For example, rigid limbs in a humanoid robot can be coupled by motorized joints, where actuation of the rigid limbs is achieved by driving movement in the motorized joints.

End effectors 116 and 117 are shown in FIG. 1 as grippers, but any end effector could be used as appropriate for a given application. For example, the end effectors can be hand-shaped members.

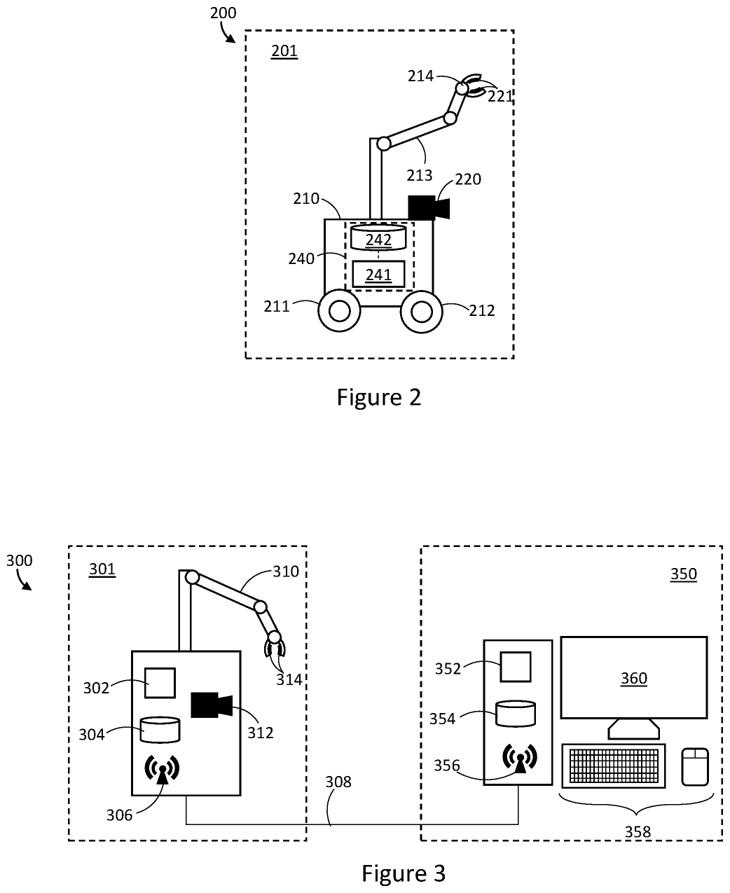

Right leg 113 and right foot 118 can together be considered as a support member and/or a locomotion member, in that the leg 113 and foot 118 together can support robot body 101 in place, or can move in order to move robot body 101 in an environment (i.e. cause robot body 101 to engage in locomotion). Left leg 115 and left foot 119 can similarly be considered as a support member and/or a locomotion member. Legs 113 and 115, and feet 118 and 119 are exemplary support and/or locomotion members, and could be substituted with any support members or locomotion members as appropriate for a given application. For example, FIG. 2 discussed later illustrates wheels as exemplary locomotion members instead of legs and feet.

Robot system 100 in FIG. 1 includes a robot body 101 that closely approximates human anatomy, such that input to or control of robot system 100 can be provided by an operator performing an action, to be replicated by the robot body 101 (e.g. via a tele-operation suit or equipment). In some implementations, it is possible to even more closely approximate human anatomy, such as by inclusion of actuatable components in a face on the head 111 of robot body 101, or with more detailed design of hands or feet of robot body 101, as non-limiting examples. However, in other implementations a complete approximation of the human anatomy is not required, and a robot body may only approximate a portion of human anatomy. As non-limiting examples, only an arm of human anatomy, only a head or face of human anatomy; or only a leg of human anatomy could be approximated.

Robot system 100 is also shown as including sensors 120, 121, 122, 123, 124, 125, 126, 127, 128, 129, and 130 which collect data. In the example, sensors 120 and 121 are image sensors (e.g. cameras) that capture visual data representing an environment of robot body 101. Although two image sensors 120 and 121 are illustrated, more or fewer image sensors could be included. Also in the example, sensors 122 and 123 are audio sensors (e.g. microphones) that capture audio data representing an environment of robot body 101. Although two audio sensors 122 and 123 are illustrated, more or fewer audio sensors could be included. In the example, haptic (tactile) sensors 124 are included on end effector 116, and haptic (tactile) sensors 125 are included on end effector 117. Haptic sensors 124 and 125 can capture haptic data (or tactile data) when objects in an environment are touched or grasped by end effectors 116 or 117. Haptic or tactile sensors could also be included on other areas or surfaces of robot body 101. In the illustrated example, sensors 120, 121, 122, 123, 124, and 125 can be considered as “environment sensors”, in that these sensors generally (but not exclusively) capture information regarding an environment in which robot body 101 is positioned. That is, image sensors capture image data, audio sensors capture audio data, and tactile sensors capture tactile data, each of which generally represents the environment or objects in the environment. However, in some scenarios it is also possible that each of these sensor types capture data representing the robot body (e.g. image data showing parts of the robot body 101, audio data representing sounds made by robot body 101, tactile data representing touch of parts of robot body 101). Thus while the term “environment sensor” provides a convenient general grouping of sensors, this term is not strictly limiting.

Also in the example, mechanic sensor 126 is included in arm 112, and mechanic sensor 127 is included in arm 114. Mechanic sensors such as sensors 126 and 127 can include a variety of possible sensors. In some examples, a mechanic sensor includes an actuator sensor which captures actuator data indicating a state of a corresponding actuator. In some examples, a mechanic sensor includes a position encoder which captures position data about at least one joint or appendage of the robot body. In some examples, a mechanic sensor includes a proprioceptive sensor which captures proprioceptive data indicating a position, movement, or force applied for a corresponding actuatable member of the robot body. More specifically, proprioceptive sensors can capture proprioceptive data, which can include the position(s) of one or more actuatable member(s) and/or force-related aspects of touch, such as force-feedback, resilience, or weight of an element, as could be measured by a torque or force sensor (acting as a proprioceptive sensor) of an actuatable member which causes touching of the element. While a mechanic sensor can be mechanical in nature in some implementations, this is not necessarily the case; mechanic sensors can also utilize properties including electrical, optical, magnetic, or of any other properties as appropriate for a given application. What is important is that the mechanic sensor measures “mechanics” pertinent to the robot system or robot body, regardless of how the sensor actually operates.

Also in the example, robot body 101 includes at least one battery 145, which provides energy to components of robot body 101. A battery sensor 128 is also included in robot body 101, which captures battery data indicating a state of battery 145 (such as voltage, incoming/outgoing current, or other pertinent battery properties).

Also in the example, inertial sensor 129 is included in leg 113, and inertial sensor 130 is included in leg 115. Inertial sensors 129 and 130 capture inertial data such as kinesthesia, motion, rotation, or inertial effects. In this regard, inertial sensors 129 and 130 can include any appropriate sensors, such as an Inertial measurement unit (IMU), and accelerometer, a gyroscope, as non-limiting examples.

In the illustrated example, sensors 126, 127, 128, 129, and 130 can be considered as “robot body sensors”, in that these sensors generally capture at least information regarding a state of some aspect of robot body 101. That is, mechanic sensors capture data pertaining to mechanical actuation, position, or movement of aspects of the robot body. Battery sensors capture data pertaining to state of a battery of the robot body. Inertial sensors capture data pertaining to position, orientation or movement of aspects of the robot body. Further, while haptic (tactile) sensors 124 and 125 were previously discussed as being “environment sensors”, such haptic sensors can also be considered as “robot body sensors”, in that haptic sensors also capture data representing haptic force, feedback, and motion of aspects of the robot body.

At least five types of sensors are illustrated in the example of FIG. 1, though more or fewer sensor types could be included. For example, audio sensors may not be included. As another example, other sensor types, such as temperature sensors, humidity sensors, pressure sensors, radiation sensors, or any other appropriate types of sensors could be included. Further, although sensors 120 and 121 are shown as approximating human eyes, and sensors 122 and 123 are shown as approximating human ears, sensors 120, 121, 122, and 123 could be positioned in any appropriate locations and have any appropriate shape. Further, the illustrated quantity and positioning of sensors is not restricted to that shown in FIG. 1. For example, any number of mechanic sensors such as 126 and 127 can be positioned at any appropriate appendages, actuators, joints, limbs, or other appropriate aspects of robot body 101. As another example, any number of inertial sensors such as 129 and 130 can be positioned at any appropriate appendages or components of robot body 101.

Throughout this disclosure, reference is made to “haptic” sensors, “haptic” feedback, and “haptic” data. Herein, “haptic” is intended to encompass all forms of touch, physical contact, or feedback. This can include (and be limited to, if appropriate) “tactile” concepts, such as texture or feel as can be measured by a tactile sensor. Unless context dictates otherwise, “haptic” can also encompass “proprioceptive” aspects of touch.

Robot system 100 is also illustrated as including at least one processor 141, communicatively coupled to at least one non-transitory processor-readable storage medium 142. The at least one processor 141 can control actuation of components 110, 111, 112, 113, 114, 115, 116, 117, 118, and 119; can receive and process data from sensors 120, 121, 122, 123, 124, 125, 126, and 127; and can determine state of the robot body 101, among other possibilities. The at least one non-transitory processor-readable storage medium 142 can have processor-executable instructions or data stored thereon, which when executed by the at least one processor 141 can cause robot system 100 to perform any of the methods discussed herein. Further, the at least one non-transitory processor-readable storage medium 142 can store sensor data, classifiers, artificial intelligence, machine learning models, other control paradigms, or any other data as appropriate for a given application. The at least one processor 141 and the at least one processor-readable storage medium 142 together can be considered as components of a “robot controller” 140, in that they control operation of robot system 100 in some capacity. While the at least one processor 141 and the at least one processor-readable storage medium 142 can perform all of the respective functions described in this paragraph, this is not necessarily the case, and the “robot controller” 140 can be or further include components that are remote from robot body 101. In particular, certain functions can be performed by at least one processor or at least one non-transitory processor-readable storage medium remote from robot body 101, as discussed later with reference to FIG. 3.

In some implementations, it is possible for a robot body to not approximate human anatomy. FIG. 2 is an elevated side view of a robot system 200 including a robot body 201 which does not approximate human anatomy. Robot body 201 includes a base 210, having actuatable components 211, 212, 213, and 214 coupled thereto. In the example, actuatable components 211 and 212 are wheels (locomotion members) which support robot body 201, and provide movement or locomotion capabilities to the robot body 201. Actuatable components 213 and 214 are a support arm and an end effector, respectively. The description for end effectors 116 and 117 in FIG. 1 is applicable to end effector 214 in FIG. 2. End effector 214 can also take other forms, such as a hand-shaped member. In other examples, other actuatable components could be included.

Robot system 200 also includes sensor 220, which is illustrated as an image sensor. Robot system 200 also includes a haptic sensor 221 positioned on end effector 214. The description pertaining to sensors 120, 121, 122, 123, 124, 125, 126, 127, 128, 129, and 130 in FIG. 1 is also applicable to sensors 220 and 221 in FIG. 2 (and is applicable to inclusion of sensors in robot bodies in general). End effector 214 can be used to touch, grasp, or manipulate objects in an environment. Further, any number of end effectors could be included in robot system 200 as appropriate for a given application or implementation.

Robot system 200 is also illustrated as including a local or on-board robot controller 240 comprising at least one processor 241 communicatively coupled to at least one non-transitory processor-readable storage medium 242. The at least one processor 241 can control actuation of components 210, 211, 212, 213, and 214; can receive and process data from sensors 220 and 221; and can determine state of the robot body 201, among other possibilities. The at least one non-transitory processor-readable storage medium 242 can store processor-executable instructions or data that, when executed by the at least one processor 241, can cause robot body 201 to perform any of the methods discussed herein. Further, the at least one processor-readable storage medium 242 can store sensor data, classifiers, artificial intelligence, machine learning models, other control paradigms, or any other data as appropriate for a given application.

FIG. 3 is a schematic diagram illustrating components of a robot system 300 comprising a robot body 301 and a physically separate remote device 350 in accordance with the present robots and methods.

Robot body 301 is shown as including at least one local or on-board processor 302, a non-transitory processor-readable storage medium 304 communicatively coupled to the at least one processor 302, a wireless communication interface 306, a wired communication interface 308, at least one actuatable component 310, at least one sensor 312, and at least one haptic sensor 314. However, certain components could be omitted or substituted, or elements could be added, as appropriate for a given application. As an example, in many implementations only one communication interface is needed, so robot body 301 may include only one of wireless communication interface 306 or wired communication interface 308. Further, any appropriate structure of at least one actuatable portion could be implemented as the actuatable component 310 (such as those shown in FIGS. 1 and 2, for example). For example, robot body 101 as described with reference to FIG. 1, or robot body 201 described with reference to FIG. 2, could be used in place of robot body 301, and communication interface 306 or communication interface 308 could be implemented therein to enable communication with remote device 350. Further still, the at least one sensor 312 and the at least one haptic sensor 314 can include any appropriate quantity or type of sensor, as discussed with reference to FIGS. 1 and 2.

Remote device 350 is shown as including at least one processor 352, at least one non-transitory processor-readable medium 354, a wireless communication interface 356, a wired communication interface 308, at least one input device 358, and an output device 360. However, certain components could be omitted or substituted, or elements could be added, as appropriate for a given application. As an example, in many implementations only one communication interface is needed, so remote device 350 may include only one of wireless communication interface 356 or wired communication interface 308. As another example, input device 358 can receive input from an operator of remote device 350, and output device 360 can provide information to the operator, but these components are not essential in all implementations. For example, remote device 350 can be a server which communicates with robot body 301, but does not require operator interaction to function. Additionally, output device 360 is illustrated as a display, but other output devices are possible, such as speakers, as a non-limiting example. Similarly, the at least one input device 358 is illustrated as a keyboard and mouse, but other input devices are possible.

In some implementations, the at least one processor 302 and the at least one processor-readable storage medium 304 together can be considered as a “robot controller”, which controls operation of robot body 301. In other implementations, the at least one processor 352 and the at least one processor-readable storage medium 354 together can be considered as a “robot controller” which controls operation of robot body 301 remotely. In yet other implementations, that at least one processor 302, the at least one processor 352, the at least one non-transitory processor-readable storage medium 304, and the at least one processor-readable storage medium 354 together can be considered as a “robot controller” (distributed across multiple devices) which controls operation of robot body 301. “Controls operation of robot body 301” refers to the robot controller's ability to provide instructions or data for operation of the robot body 301 to the robot body 301. In some implementations, such instructions could be explicit instructions which control specific actions of the robot body 301. In other implementations, such instructions or data could include broader instructions or data which guide the robot body 301 generally, where specific actions of the robot body 301 are controlled by a control unit of the robot body 301 (e.g. the at least one processor 302), which converts the broad instructions or data to specific action instructions. In some implementations, a single remote device 350 may communicatively link to and at least partially control multiple (i.e., more than one) robot bodies. That is, a single remote device 350 may serve as (at least a portion of) the respective robot controller for multiple physically separate robot bodies 301.

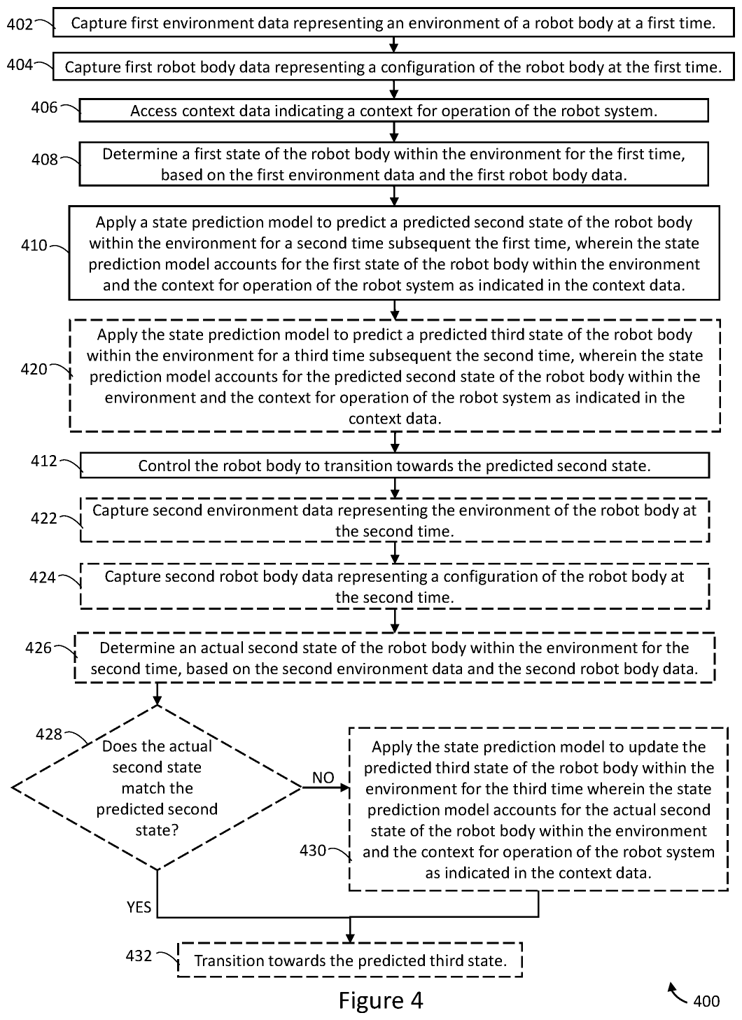

FIG. 4 is a flowchart diagram showing an exemplary method 400 of operating a robot system. Method 400 pertains to operation of a robot system, which includes a robot body, at least one environment sensor carried by the robot body, at least one robot body sensor carried by the robot body, and a robot controller which includes at least one processor and at least one non-transitory processor-readable storage medium communicatively coupled to the at least one processor. The at least one non-transitory processor-readable storage medium stores data and/or processor-executable instructions that, when executed by the at least one processor, cause the robot system to perform the method. In the exemplary implementations discussed hereafter, the system comprises a robot including a robot body such as those illustrated in FIGS. 1, 2, and 3, and optionally can include a remote device such as that illustrated in FIG. 3. Certain acts of a method of operation of a robot system may be performed by at least one processor or processing unit (hereafter “processor”) positioned at the robot body, and communicatively coupled to the non-transitory processor-readable storage medium positioned at the robot body. The robot body may communicate, via communications and networking hardware communicatively coupled to the robot body's at least one processor, with remote systems and/or remote non-transitory processor-readable storage media, as discussed above with reference to FIG. 3. Thus, unless the specific context requires otherwise, references to a robot system's processor, non-transitory processor-readable storage medium, as well as data and/or processor-executable instructions stored in a non-transitory processor-readable storage medium, are not intended to be limiting as to the physical location of the processor or non-transitory processor-readable storage medium in relation to the robot body and the rest of the robot hardware. In other words, a robot system's processor or non-transitory processor-readable storage medium may include processors or non-transitory processor-readable storage media located on-board the robot body and/or non-transitory processor-readable storage media located remotely from the robot body, unless the specific context requires otherwise. Further, a method of operation of a system such as method 400 (or any of the other methods discussed herein) can be implemented as a robot control module or computer program product. Such a robot control module or computer program product is data-based, and comprises processor-executable instructions or data that, when the robot control module or computer program product is stored on a non-transitory processor-readable storage medium of the system, and the robot control module or computer program product is executed by at least one processor of the system, the robot control module or computer program product (or the processor-executable instructions or data thereof) cause the system to perform acts of the method. In the context of method 4, generally acts of capturing data are performed by respective sensors; acts of accessing data are performed by at least one processor retrieving or receiving the data, such as from a non-transitory processor-readable storage medium (local to or remote from the at least one processor); acts of determining are performed by at least one processor; acts of applying a model are performed by at least one processor; and acts of controlling the robot body are performed by a robot controller (e.g. by at least one processor executing control instructions).

Returning to FIG. 4, method 400 as illustrated includes acts 402, 404, 406, 408, 410, 420, 412, 422, 424, 426, 428, 430, and 432, though those of skill in the art will appreciate that in alternative implementations certain acts may be omitted and/or additional acts may be added. For example, acts 420, 422, 424, 426, 428, 430, and 432 are optional acts that can be omitted as appropriate for a given application; these acts are illustrated in dashed lines to emphasize this optionality. Those of skill in the art will also appreciate that the illustrated order of the acts is shown for exemplary purposes only and may change in alternative implementations.

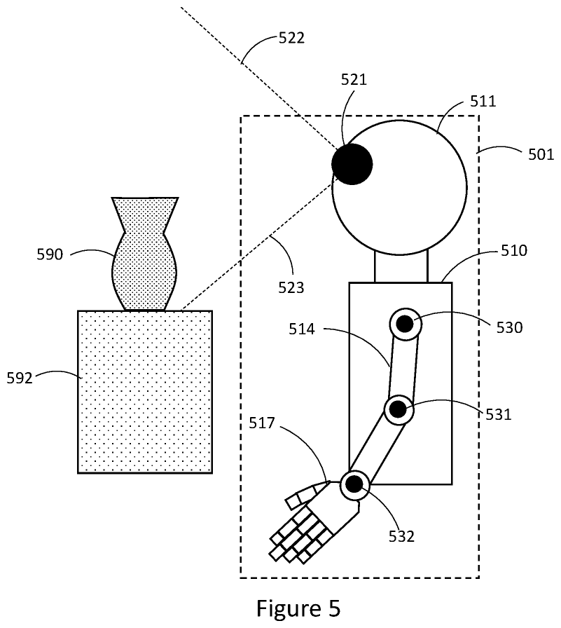

At 402, the at least one environment sensor captures first environment data representing an environment of the robot body at a first time. At 404, the at least one robot body sensor captures first robot body data representing a configuration of the robot body at the first time. At 406, the at least one processor accesses context data indicating a context for operation of the robot system. At 408, the at least one processor determines a first state of the robot body within the environment for the first time, based on the first environment data and the first robot body data. An exemplary scenario for acts 402, 404, 406, and 408 is discussed below with reference to FIG. 5.

FIG. 5 is a side-view of a partial robot body 501 positioned proximate an object 590 (a vase in the example) resting atop a pedestal 592. Robot body 501 is shown in a partial and simplified manner (e.g. with no legs or locomotion, and with limited sensors and actuatable members), in order to reduce clutter. Discussion of the robot bodies earlier with reference to FIGS. 1, 2, and 3 is fully applicable to robot body 501, and any additional robot elements can be included in robot body 501 as appropriate for a given application. Robot body 501 is controlled by a robot controller (not shown to reduce clutter); such a robot controller is similar to those described with reference to FIGS. 1, 2, and 3, and may be positioned at robot body 501, or may be positioned remote from robot body 501.

Robot body 501 is shown as having a torso 510 with a head 511 attached thereto (via a neck member). An arm member 514 is attached to torso 510, and has an end effector 517 (illustrated as a hand member) attached to an end thereof opposite the torso 510. At least one image sensor 521 is positioned at head 511. In this example, the at least one optical sensor 521 is an environmental sensor in the context of method 400 of FIG. 4, and captures image data (environment data) representing an environment of robot body 501 (shown by field of view lines 522 and 523 extending from the at least one image sensor 521. Further, mechanic sensors 530, 531, and 532 are illustrated at shoulder, elbow, and wrist joints of arm 514. The mechanic sensors can be considered as robot body sensors, and capture mechanic data regarding positions and/or actuation of components of arm 514 in the illustrated example. More or fewer sensors and sensor types can be included in robot body 501 as appropriate for a given application.

In accordance with act 402 of method 400, the at least one image sensor 521 captures image data representing an environment of robot body 501, as shown by field of view lines 522 and 523. The captured image data includes a representation of object 590.

In accordance with act 404 of method 400, the mechanic sensors 530, 531, and 532 capture robot body data indicating a position, orientation, actuation, and/or configuration of components of arm 514. In the case of FIG. 5, the robot body data indicates that the configuration of arm 514 is at the side of robot body 501.

In accordance with act 406 of method 400, a robot controller which controls robot body 501 accesses context data indicating a context for operation of the robot system. Within the context of this disclosure, “context for operation” refers to information which is useful to guide actions of the robot system, and may not be apparent from a configuration of the robot body or from an environment in which the robot body is positioned. As non-limiting examples, context data can indicate an action the robot system is to perform or is performing (e.g. a particular motion of the robot body, such as “grasp object”); context data can indicate a task to which the robot system is directed (e.g. a specific objective to be achieved, such as “move an object to a position”); context data can indicate a role which the robot system is serving (e.g. a general area of service to which the robot is directed, such as nurse, repair worker, or any other appropriate role).

Context data may include labels indicating instruction sets which are available for the robot controller to execute. Instruction sets, as discussed in more detail later, can include one or more parameterized action primitives or reusable work primitives performable by the robot body. In one implementation, a library of instruction sets is stored on at least one non-transitory processor-readable storage medium accessible to the robot controller. This library of instruction sets includes many instruction sets for use by the robot in many different contexts. Consequently, not every instruction set will be relevant in every context in which the robot operates, and thus some instruction sets are disabled (made unavailable to the robot) for certain contexts in which the robot body operates. Whether a particular instruction set is available for execution by the robot controller can be indicated by a binary label (i.e. “available” or “not available”).

Many other types of context data are possible, and the context data can indicate any appropriate context.

In some implementations (such as shown in FIGS. 1 and 2), the robot controller is carried by the robot body. In such implementations, accessing the context data can comprise retrieving the context data from the at least one non-transitory processor-readable storage medium of the robot controller. Alternatively in such implementations, accessing the context data can comprise receiving the context data from a remote device remote from the robot body. In accordance with act 408 of method 400, the at least one processor of the robot controller determines a first state of robot body 501. This is based on the environment data (the image data from image sensor 521) and the robot body data (the data from mechanic sensors 530, 531, and 532). In the example of FIG. 5, the at least one processor of the robot controller determines that robot body 501 is positioned in front of object 590, and is standing erect with arm 514 hanging downwards from torso 510. Throughout this disclosure, a state of a robot body can be expressed according to equation (1) below:

$$P ( t ) = S ( t ) + C ( t ) \qquad ( 1 )$$

In Equation (1), t represents time, P represents a state of the robot body, S represents sensor data (from environment sensors and robot body sensors), and C represents context data. Thus, P(t) represents a state of the robot body at time t, S(t) represents sensor data at time t, and C(t) represents context data for time t. In the example of FIG. 5, with the first time as time t, P(t) corresponds to the first state of robot body 501.

Returning to FIG. 4, at 410 in method 400, a state prediction model is applied to predict a predicted second state of the robot body within the environment for a second time subsequent the first time. The state prediction model accounts for the first state of the robot body within the environment and the context for operation of the robot system as indicated in the context data.

In an exemplary implementation, the state prediction model is trained to predict what state typically follows (e.g. is statistically most likely to follow) another state. That is, with reference to Equation (1) above, given a state P(t), the state prediction model is trained to predict a state P(t+t′) which typically follows state P(t). In this example, t′ represents a difference in time. Commonly, t′is short, such as one second or less, because the state prediction model can most accurately predict a subsequent state a short time in the future, with accuracy generally decreasing as t′ increases. However, this is not necessarily the case, and t′ can be any appropriate length of time which the state prediction model can handle with acceptable accuracy. Details of the state prediction model, and how the model is trained, are discussed later.

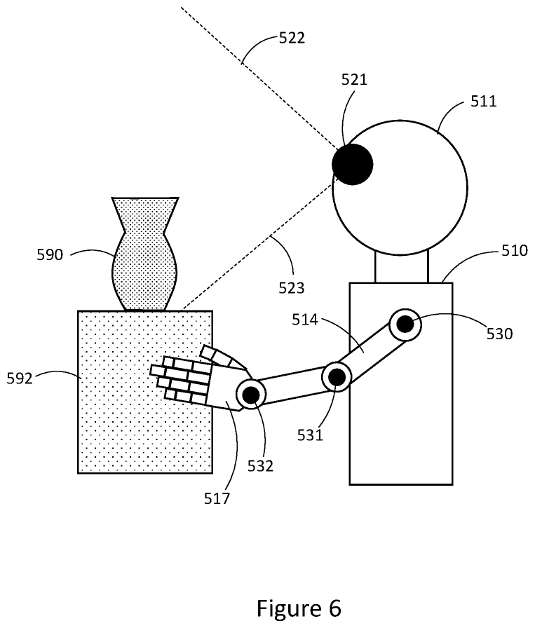

An exemplary second state is shown in FIG. 6. FIG. 6 is a side-view of partial robot body positioned proximate object 590, similar to as discussed with reference to FIG. 5. Unless context dictates otherwise, description of FIG. 5 is applicable to FIG. 6, and is not repeated for brevity. The label for robot body 501, as shown in FIG. 5, is not shown in FIG. 6 to reduce clutter. Nonetheless the robot body in FIG. 6 can be considered as robot body 501.

FIG. 6 illustrates the robot body in a second state. At 410, this second state is predicted, accounting for the first state of the robot body within the environment and the context for operation of the robot system as indicated in the context data, as discussed above. In the second state, arm 514 is moved up towards the object 590, relative to in the first state shown in FIG. 5.

Returning to method 400 in FIG. 4, act 420 is optional, and is discussed later.

At 412, the robot body is controlled to transition towards the predicted second state. In the example of FIGS. 5 and 6, robot body 501 is controlled (e.g. by the robot controller executing control instructions) to actuate arm 514 from the position shown in FIG. 5 towards the position shown in FIG. 6.

Acts 422, 424, 426, 428, 430, and 432 are optional, and can be implemented differently as appropriate for a particular implementation.

In an exemplary implementation, acts 420, 422, 424, 426, 428, 430, and 432 are executed. In this exemplary implementation, act 420 occurs before the second time. At 420, the state prediction model is applied to predict a third predicted state of the robot body within the environment for a third time subsequent the second time, wherein the state prediction model accounts for the predicted second state of the robot body within the environment and the context for operation of the robot system as indicated in the context data. In the example of FIGS. 5 and 6, the third state is predicted based on the predicted second state as shown in FIG. 6, prior to the robot body actually arriving at this second state. That is, the predicted third state is predicted at least one state in advance.

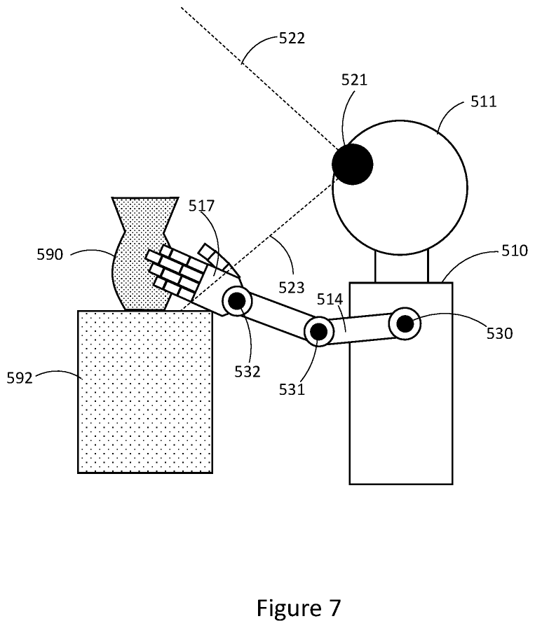

An exemplary third state is shown in FIG. 7. FIG. 7 is a side-view of partial robot body positioned proximate object 590, similar to as discussed with reference to FIGS. 5 and 6. Unless context dictates otherwise, description of FIGS. 5 and 6 is applicable to FIG. 7, and is not repeated for brevity. The label for robot body 501, as shown in FIG. 5, is not shown in FIG. 7 to reduce clutter. Nonetheless the robot body in FIG. 7 can be considered as robot body 501.

FIG. 7 illustrates the robot body in a third state. At 420, this third state is predicted, accounting for the predicted second state of the robot body within the environment (shown in FIG. 6) and the context for operation of the robot system as indicated in the context data, as discussed above. In the third state, arm 514 is moved even further up towards the object 592, relative to in the second state shown in FIG. 6. In the third state shown in FIG. 7, hand 517 is touching object 590.

Returning to method 400, in the exemplary implementation, acts 422, 424, 426, 428, 430, and 432 occur at or after the second time (when or after the robot body is expected to have transitioned to the second state).

At 422, second environment data is captured by the at least one environment sensor. The second environment data represents the environment of the robot body at the second time. At 424, second robot body data is captured by the at least one robot body sensor. The second robot body data represents a configuration of the robot body at the second time. Capturing environment data at 422 and capturing robot body data at 424 are similar to capturing environment data at 402 and capturing robot body data at 404, respectively. Description of acts 402 and 404 applies to acts 422 and 424, respectively, unless context requires otherwise. In particular, acts 422 and 424 are focused on data capture at a second time, whereas acts 402 and 404 are focused on data capture at a first time before the second time.

At 426, an actual second state of the robot body within the environment for the second time is determined, based on the second environment data and the second robot body data captured. In the example of FIGS. 5, 6, and 7, it is determined whether the arm 514 has moved upwards as expected, e.g. based on data captured from mechanic sensors 530, 531, and 532, and based on image data from image sensor 521 (which in this example should not include a representation of arm 514). Throughout this disclosure, determining whether an actual state matches a predicted state can also be referred to as validating the state.

At 428, the actual second state as determined at 426 is compared to the predicted second state as predicted at 410. If the actual second state and the predicted second state match (e.g., components of robot body 501 are within tolerance thresholds of expected positions and orientations of said components), method 400 proceeds to act 432. In act 432, the robot body is controlled (by the robot controller) to transition towards the predicted third state (as predicted in act 420). Transitioning of the robot body towards the predicted third state is similar to transitioning towards the second predicted state, and description of such transitioning is not repeated for brevity.

If at 428 the actual second state is determined as not matching the predicted second state, method 400 proceeds to act 430.

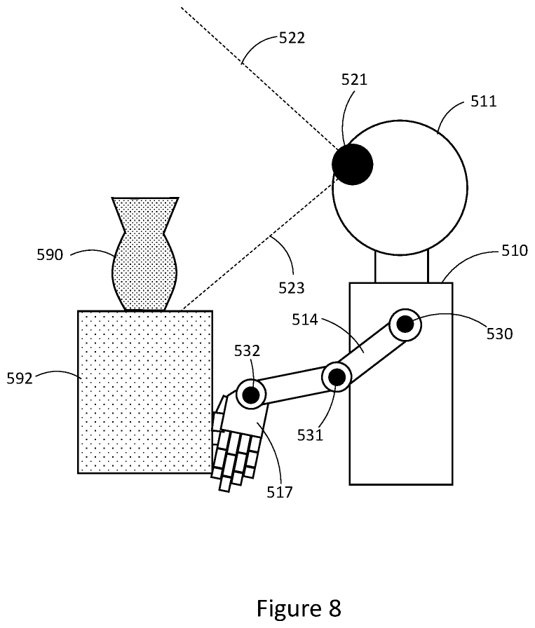

FIG. 8 illustrates an exemplary actual state at the second time which does not match a predicted second state. FIG. 8 is a side-view of partial robot body positioned proximate object 590, similar to as discussed with reference to FIGS. 5, 6, and 7. Unless context dictates otherwise, description of FIGS. 5, 6, and 7 is applicable to FIG. 8, and is not repeated for brevity. The label for robot body 501, as shown in FIG. 5, is not shown in FIG. 8 to reduce clutter. Nonetheless the robot body in FIG. 8 can be considered as robot body 501.

In the actual state shown in FIG. 8, arm 514 has moved up towards the object 590, relative to the first state shown in FIG. 5, but hand 517 has collided with pedestal 592. As a result, the position of hand 517 has contorted, and is not close to the predicted second state shown in FIG. 6. This could have happened, for example, because the robot controller inaccurately characterized the dimensions, placement, or orientation of pedestal 592, such that hand 517 is not able to move upwards alongside pedestal 592 via a trajectory that connects the first state to the predicted second state.

Returning to method 400 in FIG. 4, when it is determined at 428 that the actual second state does not match the predicted second state, method 400 proceeds to act 430.

At 430, the state prediction model is applied to update the predicted third state of the robot body within the environment for the third time subsequent the second time. The state prediction model accounts for the actual second state of the robot body within the environment and the context for operation of the robot system as indicated in the context data. That is, when the robot is determined as not operating as predicted, a future predicted state of the robot is updated to accurately reflect an actual current state of the robot body.

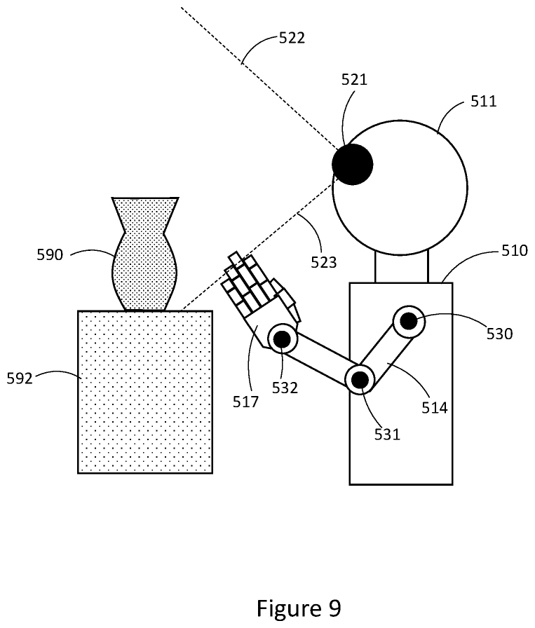

FIG. 9 illustrates an exemplary updated predicted third state for the robot body which accounts for the actual second state of the robot body shown in FIG. 8. FIG. 9 is a side-view of partial robot body positioned proximate object 590, similar to as discussed with reference to FIGS. 5, 6, 7, and 8. Unless context dictates otherwise, description of FIGS. 5, 6, 7, and 8 are applicable to FIG. 9, and is not repeated for brevity. The label for robot body 501, as shown in FIG. 5, is not shown in FIG. 9 to reduce clutter. Nonetheless the robot body in FIG. 9 can be considered as robot body 501.

In the updated third state shown in FIG. 9, arm 514 has bent more at the elbow (where mechanic sensor 531 is positioned) compared to the second state shown in FIG. 8, such that hand 517 does not collide with pedestal 592. Hand 517 has also been moved up towards the object 590, relative to the second state shown in FIG. 8.

After updating the predicted third state, method 400 proceeds to act 432, where the robot body is controlled to transition towards the predicted third state (as updated), similar to as discussed above.

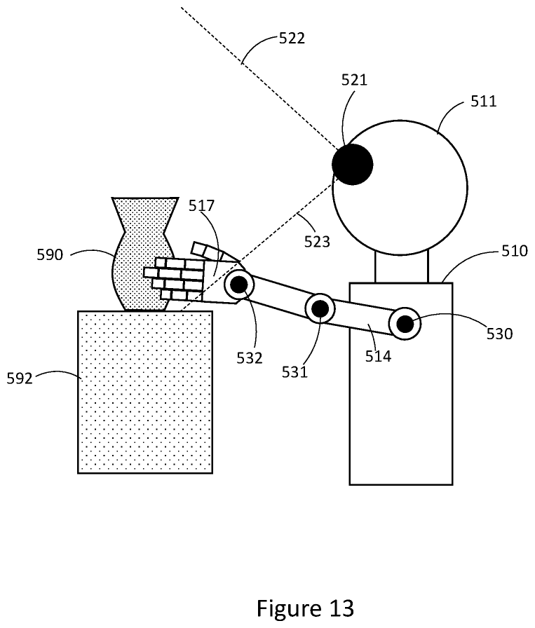

Method 400, including optional acts 420, 422, 424, 426, 428, 430, and 432, shows an implementation where states of the robot body are predicted, transitioned towards, and later validated, such that updates can be made to future predicted states in the event transition is unsuccessful, inaccurate, or otherwise not as intended. Further, while method 400 illustrates three states for the robot body, method 400 can be extended to any appropriate number of states. As one example, an additional state could be included after the third state shown in FIG. 9, where the robot body extends arm 514 forward (left in the page) such that hand 517 touches object 590 (as shown in FIG. 13 discussed later).

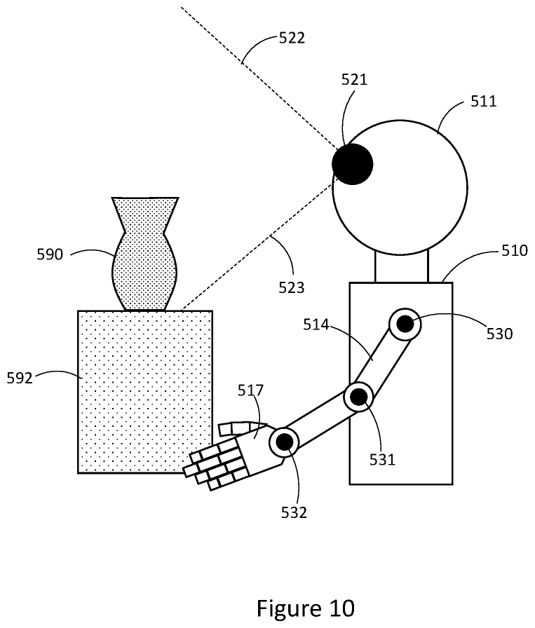

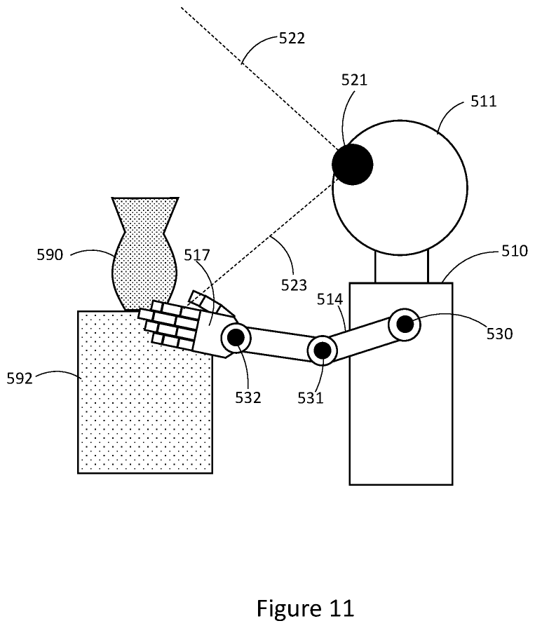

In some implementations, after transitioning towards each predicted state, an actual state of the robot body is compared to the respective predicted state, and other predicted states are updated as a result (in accordance with acts 422, 424, 426, 428, and 430). That is, the transition to each state is validated in such implementations. However, in other implementations, not every transition or state of the robot body is validated. Rather, select states are validated as appropriate. An example is discussed below, with reference to FIGS. 10 and 11.

FIG. 10 illustrates an exemplary fourth state between the first state shown in FIG. 5 and the second state shown in FIG. 6. That is, FIG. 10 illustrates an exemplary state of the robot body at a fourth time between the first time and the second time. FIG. 10 is a side-view of partial robot body positioned proximate object 590, similar to as discussed with reference to FIGS. 5, 6, 7, 8, and 9. Unless context dictates otherwise, description of FIGS. 5, 6, 7, 8 and 9 are applicable to FIG. 10, and is not repeated for brevity. The label for robot body 501, as shown in FIG. 5, is not shown in FIG. 10 to reduce clutter. Nonetheless the robot body in FIG. 10 can be considered as robot body 501.

Numerical labels for states and times are used to differentiate states and times from each other, but do not necessarily indicate a sequential order of states or times. In the discussed example, the fourth state occurs after the first state but before the second state (the fourth time occurs after the first time but before the second time). Similarly for the example of FIG. 11 discussed later, the fifth state occurs after the second state but before the third state (the fifth time occurs after the second time but before the third time).

In the fourth state shown in FIG. 10, arm 514 has moved up towards the object 590, relative to in the first state shown in FIG. 5, but has not yet moved up towards object 590 as far as in the second state shown in FIG. 6. Prior to the fourth time, the state prediction model is applied (in accordance with act 410 of method 400) to predict the fourth state. Further, the robot body is controlled to transition towards the predicted fourth state in accordance with act 412 of method 400. In the exemplary implementation, an actual fourth state is not validated; that is, acts 422, 424, 426, 428, 430, and 432 are not performed for the fourth state. Instead, the robot controller assumes correct transition to the fourth state, and continues to operate the robot body to transition towards the second state illustrated in FIG. 6. Acts 422, 424, 426, 428, 430, and 432 are performed as appropriate (as discussed earlier) to validate transition to the second state.

FIG. 11 illustrates an exemplary fifth state between the second state shown in FIG. 6 and the third state shown in FIG. 7. That is, FIG. 11 illustrates an exemplary state of the robot body at a fifth time between the second time and the third time. FIG. 11 is a side-view of partial robot body positioned proximate object 590, similar to as discussed with reference to FIGS. 5, 6, 7, 8, 9, and 10. Unless context dictates otherwise, description of FIGS. 5, 6, 7, 8, 9, and 10 are applicable to FIG. 11, and is not repeated for brevity. The label for robot body 501, as shown in FIG. 5, is not shown in FIG. 11 to reduce clutter. Nonetheless the robot body in FIG. 11 can be considered as robot body 501.

In the fifth state shown in FIG. 11, arm 514 has moved up towards the object 590, relative to in the second state shown in FIG. 6, but has not yet moved up towards object 590 as far as in the third state shown in FIG. 7. For this fifth state, the state prediction model is applied (in accordance with act 410 of method 400) to predict the fifth state. Further, the robot body is controlled to transition towards the predicted fifth state in accordance with act 412 of method 400. In the exemplary implementation, an actual fifth state is not validated; that is, acts 422, 424, 426, 428, 430, and 432 are not performed for the fifth state. Instead, the robot controller assumes correct transition to the fifth state, and continues to operate the robot body to transition towards the third state illustrated in FIG. 7. Acts 422, 424, 426, 428, 430, and 432 are performed as appropriate (as discussed earlier) to validate transition to the third state.

FIGS. 10 and 11 (in combination with FIGS. 5, 6, and 7 discussed earlier) illustrate an exemplary implementation where some, but not all, of the transitions to states are validated. In the discussed example, every alternate state is validated, but any appropriate number or frequency of states can be validated. In such implementations, a balance is achieved where control of the robot body is still reasonably accurate (by selective validation of states), without undue burden on processing resources (which would be caused by validating every single state).

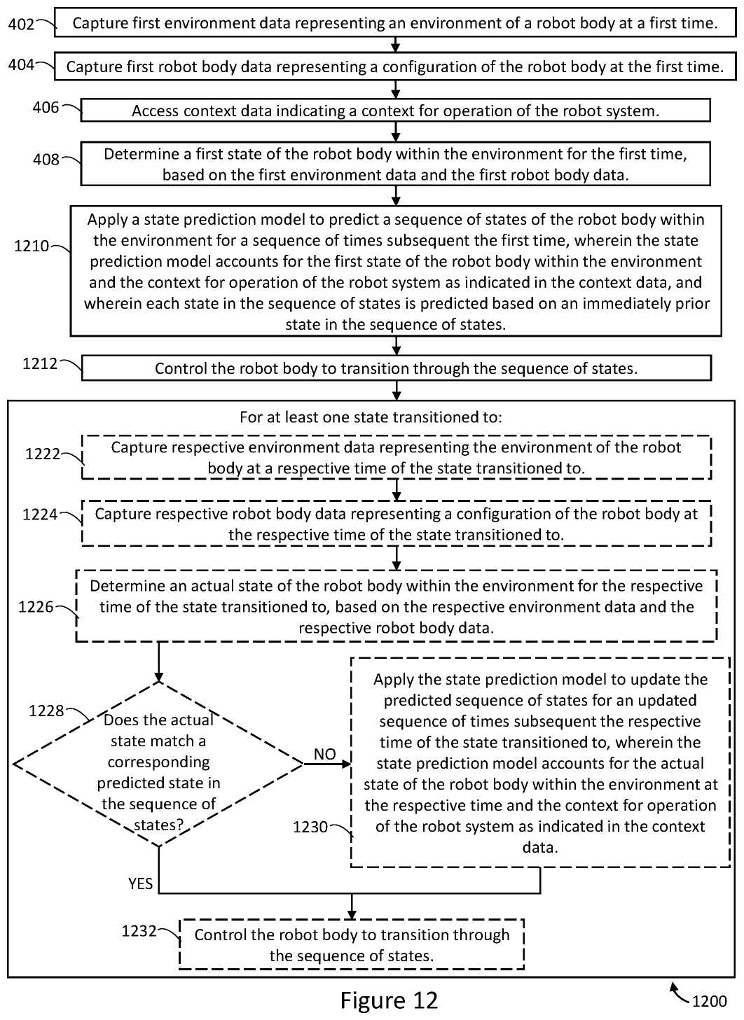

FIG. 12 is a flowchart diagram showing an exemplary method 1200 of operating a robot system. Method 1200 pertains to operation of a robot system, which includes a robot body, at least one environment sensor carried by the robot body, at least one robot body sensor carried by the robot body, and a robot controller which includes at least one processor and at least one non-transitory processor-readable storage medium communicatively coupled to the at least one processor. The at least one non-transitory processor-readable storage medium stores data and/or processor-executable instructions that, when executed by the at least one processor, cause the robot system to perform the method. In the exemplary implementations discussed hereafter, the system comprises a robot including a robot body such as those illustrated in FIGS. 1, 2, and 3, and optionally can include a remote device such as that illustrated in FIG. 3. Certain acts of a method of operation of a robot system may be performed by at least one processor or processing unit (hereafter “processor”) positioned at the robot body, and communicatively coupled to the non-transitory processor-readable storage medium positioned at the robot body. The robot body may communicate, via communications and networking hardware communicatively coupled to the robot body's at least one processor, with remote systems and/or remote non-transitory processor-readable storage media, as discussed above with reference to FIG. 3. Thus, unless the specific context requires otherwise, references to a robot system's processor, non-transitory processor-readable storage medium, as well as data and/or processor-executable instructions stored in a non-transitory processor-readable storage medium, are not intended to be limiting as to the physical location of the processor or non-transitory processor-readable storage medium in relation to the robot body and the rest of the robot hardware. In other words, a robot system's processor or non-transitory processor-readable storage medium may include processors or non-transitory processor-readable storage media located on-board the robot body and/or non-transitory processor-readable storage media located remotely from the robot body, unless the specific context requires otherwise. Further, a method of operation of a system such as method 1200 (or any of the other methods discussed herein) can be implemented as a robot control module or computer program product. Such a robot control module or computer program product is data-based, and comprises processor-executable instructions or data that, when the robot control module or computer program product is stored on a non-transitory processor-readable storage medium of the system, and the robot control module or computer program product is executed by at least one processor of the system, the robot control module or computer program product (or the processor-executable instructions or data thereof) cause the system to perform acts of the method. In the context of method 12, generally acts of capturing data are performed by respective sensors; acts of accessing data are performed by at least one processor retrieving or receiving the data, such as from a non-transitory processor-readable storage medium (local to or remote from the at least one processor); acts of determining are performed by at least one processor; acts of applying a model are performed by at least one processor; and acts of controlling the robot body are performed by a robot controller (e.g. by at least one processor executing control instructions).

Returning to FIG. 12, method 1200 as illustrated includes acts 402, 404, 406, 408, 1210, 1212, 1222, 1224, 1226, 1228, 1230, and 1232, though those of skill in the art will appreciate that in alternative implementations certain acts may be omitted and/or additional acts may be added. For example, acts 1222, 1224, 1226, 1228, 1230, and 1232 are optional acts that can be omitted as appropriate for a given application; these acts are illustrated in dashed lines to emphasize this optionality. Those of skill in the art will also appreciate that the illustrated order of the acts is shown for exemplary purposes only and may change in alternative implementations.

In some regards, method 1200 in FIG. 12 is similar to method 400 in FIG. 4, and description of method 400 is applicable to method 1200 unless context dictates otherwise.

Acts 402, 404, 406, and 408 in method 1200 are similar to as in method 400, and description of these acts is not repeated for brevity.

Act 1210 in method 1200 is similar to act 410 in method 400. At 1210, a state prediction model is applied to predict a sequence of states of the robot body within the environment for a sequence of times subsequent the first time. The state prediction model accounts for the first state of the robot body within the environment and the context for operation of the robot system as indicated in the context data, and each state is predicted based on an immediately prior state in the sequence of states.

In an illustrative example where FIG. 5 illustrates robot body 501 in a first state within an environment, the predicted sequence of states includes (in sequential order) the fourth state shown in FIG. 10, the second state shown in FIG. 6, the fifth state shown in FIG. 11, and the third state shown in FIG. 7. In this illustrative example, prediction of the fourth state is based on the first state; prediction of the second state is based on the fourth state; prediction of the fifth state is based on the second state; and prediction of the third state is based on the fifth state.

Returning to FIG. 12, act 1212 in method 1200 is similar to act 412 in method 400. At 1212, the robot body is controlled (by the robot controller) to transition through the sequence of states. In the illustrative example of FIGS. 5, 6, 7, 10, and 11, the robot body is controlled to transition through the first state, fourth state, second state, fifth state, and third state. In some cases, however, act 1212 does not necessarily entail transitioning through the sequence of states as initially predicted at act 1210. In particular, in some implementations transitions are validated, and updates to the sequence of states may be made, as discussed below regarding acts 1222, 1224, 1226, 1228, 1230, and 1232.

Acts 1222, 1224, 1226, 1228, 1230, and 1232 in method 1200 are similar to acts 422, 424, 426, 428, 430, and 432 in method 400. Acts 1222, 1224, 1226, 1228, 1230, and 1232 are performed for at least one state transitioned to in the sequence of states. Acts 1222, 1224, 1226, 1228, 1230, and 1232 are optional, in that they may not be performed at all, or they may not be performed for each state in the sequence of states. In contrast, in some implementations 1222, 1224, 1226, 1228, 1230, and 1232 are performed for each state in the sequence of states.

At 1222, respective environment data is captured by the at least one environment sensor. The respective environment data represents the environment of the robot body at the time of the state transitioned to (the particular state being validated). At 1224, respective robot body data is captured by the at least one robot body sensor. The respective robot body data represents a configuration of the robot body at the time of the state transitioned to (the particular state being validated). Capturing environment data at 1222 and capturing robot body data at 1224 are similar to capturing environment data at 402 and capturing robot body data at 404, respectively, in method 400. Description of acts 402 and 404 applies to acts 1222 and 1224, respectively, unless context requires otherwise.

At 1226, an actual state of the robot body within the environment for the respective time of the state transitioned to is determined, based on the respective environment data and the respective robot body data captured. Determination of the actual state is similar to as described for act 426 of method 400, and is not repeated for brevity.

At 1228, the actual state as determined at 1226 is compared to a corresponding predicted state in the sequence of states as predicted at 1210. What is meant by a “corresponding” predicted state is a predicted state for the robot body at the time of the actual state as transitioned to. If the actual state and the predicted state match (e.g., components of robot body 501 are within tolerance thresholds of expected positions and orientations of said components), method 1200 proceeds to act 1232. In act 1232, the robot body is controlled to continue transitioning through the predicted sequence of states.

If at 1228 the actual state is determined as not matching the corresponding predicted state, method 1200 proceeds to act 1230. At 1230, the state prediction model is applied to update the predicted sequence of states of the robot body within the environment for an updated sequence of times subsequent the respective time of the state transitioned to. The state prediction model accounts for the actual state of the robot body within the environment at the respective time and the context for operation of the robot system as indicated in the context data. That is, when the robot is determined as not operating as predicted, the predicted sequence of states for the future of the robot is updated to accurately reflect an actual current state of the robot body.

Examples of applications of method 1200 in FIG. 12 are discussed below with reference to FIGS. 5, 6, 7, 8, 9, 10, and 11.

In a first example, the first state of the robot body is shown in FIG. 5, and the sequence of states is predicted (in accordance with act 1210) as including (in sequential order) the fourth state shown in FIG. 10, the second state shown in FIG. 6, the fifth state shown in FIG. 11, and the third state shown in FIG. 7. Further in the first example, the second state shown in FIG. 7 is subject to validation (verification in accordance with acts 1222, 1224, 1226, 1228, 1230, and 1232), whereas the other states are not. One skilled in the art will appreciate that more or fewer states could be included in the predicted sequence of states, and/or that more or fewer states could be subject to validation, as appropriate for a given application.

In the first example, after transitioning to the second state shown in FIG. 6 (via the fourth state shown in FIG. 10), acts 1222, 1224, 1226, 1228, 1230, and 1232 are performed. Based on environment data and robot body data collected at 1222 and 1224, the actual second state of the robot body is determined at 1226. In this first example, the actual second state matches a corresponding second state as predicted in the sequence of states of 1210. As a result, method 1200 proceeds to 1232, where the robot body is controlled to continue to transition through the sequence of states. In this first example, act 1232 entails controlling the robot body to transition to the fifth state shown in FIG. 11, then the third state shown in FIG. 7.

A second example is discussed below, which is similar to the first example, description of the first example is generally applicable to the second example except where context dictates otherwise. One difference between the second example and the first example is that, in the second example, the actual second state does not match a corresponding second state in the predicted sequence of states. In particular, in transitioning to the second state (via the fourth state), the robot body ends up in the actual state shown in FIG. 8.

As discussed earlier, in the actual state shown in FIG. 8, arm 514 has moved up towards the object 590, relative to in the first state shown in FIG. 5, but hand 517 has collided with pedestal 592. As a result, the position of hand 517 has contorted, and is not close to corresponding second state as predicted in the sequence of states.

Because the actual state does not match a corresponding predicted state in the sequence of states at 1228, method 1200 goes to act 1230. At 1230, the state predication model is applied to update the predicted sequence of states for an updated sequence of times subsequent the time of the actual state shown in FIG. 8. Accounting for environment data captured at 1222, robot body data captured at 1224, and context data accessed at 406, the state prediction model is applied to update the predicted sequence of states: the fifth state shown in FIG. 11 and the third state shown in FIG. 7 are replaced with an updated third state shown in FIG. 9, and a sixth state shown in FIG. 13 discussed later. The entire sequence of states does not necessarily need to be updated. For example, previous states in the sequence do not need to be updated. As another example, the sequence of states may only be updated to the extent that a motion path or multiple motion paths are determined which cause components of the robot body to move in ways that bring the robot body back into alignment with what is expected in the predicted sequence of states (e.g. backtracking and retrying movement, or performing an intermediate action that moves the robot body to a position or orientation as predicted later in the sequence of states).

As discussed earlier, in the updated third state shown in FIG. 9, arm 514 has bent more at the elbow (where mechanic sensor 531 is positioned) compared to the second state shown in FIG. 8, such that hand 517 does not collide with pedestal 592. Hand 517 has also been moved up towards the object 590, relative to the second state shown in FIG. 8.

FIG. 13 illustrates an exemplary sixth state for the robot body which accounts for the actual second state of the robot body shown in FIG. 8. FIG. 13 is a side-view of partial robot body positioned proximate object 590, similar to as discussed with reference to FIGS. 5, 6, 7, 8, 9, 10, and 11. Unless context dictates otherwise, description of FIGS. 5, 6, 7, 8, 9, 10, and 11 are applicable to FIG. 13, and is not repeated for brevity. The label for robot body 501, as shown in FIG. 5, is not shown in FIG. 13 to reduce clutter. Nonetheless the robot body in FIG. 13 can be considered as robot body 501.

In the sixth state shown in FIG. 13, arm 514 is relatively straight compared to the third state shown in FIG. 7, with hand 517 touching object 590.

After updating the predicted sequence of states, method 1200 proceeds to act 1232, where the robot body is controlled to transition through the updated sequence of states. In this second example, the robot body is controlled to transition to the updated third state shown in FIG. 9, then the sixth state shown in FIG. 13.

In this second example, by validating transition to a state, an error was accounted for, such that the robot body still reaches the ultimate conclusion of touching object 590, but via an updated sequence of states.

Throughout this disclosure, reference is made to state prediction models which are applied to predict states of a robot body. Details of an exemplary form of such a state prediction model, as a machine-learning based model, are discussed below.

As discussed earlier with reference to Equation (1), the state prediction model is trained to predict what state typically follows another state. That is, with reference to Equation (1), given a state P(t), the state prediction model is trained to predict a state P(t+t′) which follows state P(t), where t′ represents a difference in time. To achieve this, the model learns statistical knowledge of the world, and of how the world changes in time from the first-person perspective of the robot body. The model can be used for multiple different purposes, but when t′ represents a short difference in time (approximately 1 second duration or less), the state prediction model is generally most effective for motion planning for executing parametrized action primitives drawn from an Instruction Set of parameterized action primitives. Parameterized action primitives may alternately be referred to as “reusable work primitives”, or simply “primitives”. Primitives are discussed in detail in U.S. patent application Ser. No. 17/566,589 and U.S. patent application Ser. No. 17/883,737, the entirety of which are incorporated by reference herein.

In the context of a robot, primitives may correspond to basic low-level functions that the robot is operable to (e.g., autonomously or automatically) perform and that the robot may call upon or execute in order to achieve something. Examples of primitives for a humanoid robot include, without limitation: look up, look down, look left, look right, move right arm, move left arm, close right end effector, open right end effector, close left end effector, open left end effector, move forward, turn left, turn right, move backwards, and so on; however, a person of skill in the art will appreciate that: i) the foregoing list of exemplary primitives for a humanoid robot is by no means exhaustive; ii) the present robots, systems, control modules, computer program products, and methods are not limited in any way to robots having a humanoid form factor; and iii) the complete composition of any library of primitives depends on the design and functions of the specific robot for which the library of primitives is constructed.

In the context of Equation (1), the below discussion references a robot body comprising a set of sensors (where the sensors are indexed by j) measuring a set of time series first person perspective sensor inputs {Sᵢ(t)} and context information that is important but is not captured by a sensor {cₖ(t)} (where different aspects of context information are indexed by k). In this discussion, a state prediction model is trained in two stages: a foundational model stage, followed by a policy stage. However, other state prediction models, and other ways to train such state prediction models, are still compatible with the systems, methods, control modules, and computer program products discussed herein.

To train a foundational model of first-person robot experience, any appropriate sets of sensor data {Sᵢ(t)} can be used for training; sets of context information {cₖ(t)} are not used yet. That is, the foundational stage focuses on what the robot experiences (as indicated in sensor data), and is absent semantic or task-based use (as indicated in context information). At this foundational stage the model is being trained to learn the statistics of the temporal evolution of the robot body's first-person perspective. This stage does not require extra-sensory labels and can be largely self-supervised. The data can come from random environments and random movements in those environments. This can come from either simulated environments or real physical environments. For this foundational stage, it is not necessary for a simulated environment to be high fidelity to physical reality; rather, at this foundational stage the model need only be trained to predict whatever will happen in the simulated environment, even if the ‘physics’ of the simulated environment do not match the physics of reality.

In order to test the foundational model, first-person sensor data over time in a “Ground Truth” data set can be compared to predictions of the foundational model. In particular, the Ground Truth data set can be compared to model predictions for at least two levels of abstraction extracted over short-time predictions: (1) raw sensor data (e.g. pixel level in image data, joint encoder readings in proprioceptive data, or any other appropriate sensor data); and (2) Feature Extraction level. For level (2), the Ground Truth data set and model predictions are fed through Feature Extraction pipelines, and extracted features are compared as a measure of fitness of the model. Features extracted can include object labels and six degrees-of-freedom poses for a small collection of objects specified in an Asset Library (i.e., a database of known objects for which object models are stored, discussed in detail later).

In an exemplary implementation, the foundational model generates a “Scene Graph”, which is a list of instances of objects and corresponding parameters (e.g. position, orientation, color, or any other appropriate parameters) for an environment of the robot body. The robot body itself can be one of said objects, with parameters relating to data collected by robot body sensors. To test (and train based on the results of testing) the foundational model, a simulated environment can be used as “Ground Truth”, since objects in the simulated environment and parameters thereof are precisely known, and thus differences from this simulated environment accurately reflect fitness of the model. The model can be trained to generate a scene graph for such a simulated environment, where the generated scene graph is compared to the ground truth data for the simulated environment itself.

Once a foundational model is trained and performing well, it can be used to generate policies for executing Instruction Set commands (i.e. commands to perform one or more primitives in an Instruction Set as discussed earlier). Consider the set {cₖ(t)} to comprise, for example, binary labels specifying which Instruction Set elements (which primitives) are available, and what parameters of the primitives are available. In this context, what is meant by primitives and parameters being available is that, for the context specified by {cₖ(t)}, some primitives (and corresponding parameters) are applicable, whereas some are not applicable and are thus made unavailable. In an exemplary implementation, multiple types of end effectors could be swapped for a robot body, as appropriate for an application or context in which the robot is being deployed. When said robot body is being deployed as a lumberjack (in a tree-cutting role), a chainsaw end effector may be installed on the robot (or the robot may have a humanoid hand operable to hold and control the chainsaw). In contrast, when said robot body is deployed as an assistant in a nursing home, the chainsaw end effector is replaced with a less threatening humanoid hand. When deployed in the lumberjack context, primitives directed to controlling a chainsaw are available, because the robot needs to use a chainsaw to perform the task. Similarly, when deployed in the nursing home context, primitives directed to controlling a chainsaw are not available, because the robot is not equipped with the chainsaw. Further, certain parameters of available primitives may also be unavailable. In the nursing home context, parameters which enable strong gripping of the humanoid hand may not be available, so as to avoid harming a person.

In some implementations, the context {cₖ(t)} includes information about what specific task(s) the robot is performing at time t. In this way, the characterization of the state of the robot (and subsequent state(s) predicted by the state prediction model) may be dependent on what task(s) the robot is actually doing at that time. For example, a context-aware state prediction model may predict a completely different second state for a robot with sensor inputs S(t) that is chopping vegetables compared to a robot with the same sensor inputs S(t) that is cleaning a bathroom counter.

For a context {cₖ(t)}, a fine-tuning dataset {Sᵢ(t)} is accessed which represents a large number of episodes of sensor data captured under the conditions implied by {cₖ(t)}. Each of these episodes is initially performed by a robot body under analogous tele-operation control by a human pilot. This fine-tuning dataset is used to further train the model to be able to predict (statistically) a subsequent state of the robot body based on sensor data and on context.

Earlier, the concept of scene graphs was discussed. In generating a scene graph, an asset library can be used to populate objects in the scene graph. The Asset Library is a collection of object classes, where some parameters for each class are fixed and some parameters are variable. For example, a member of the Asset Library could be: chess_king={6DOF; color; fixed_mesh}.

In this example, “fixed_mesh” is fixed to the class and defines the surface of the object, while “6DOF” and “color” are parameters set on a per instance basis. Specifically, “6DOF” refers to six degrees of freedom of an instance of the asset (three degrees of freedom which indicate position, and three degrees of freedom which indicate orientation, of the instance in the environment). “Color” refers to a color of an instance of the asset.

In generating a scene graph, this format allows prior information about an object to be populated (e.g. shape), without having to learn it or explicitly extract it from perception (sensor data). A specific concrete instance of this class could be for example: chess_king_001={6DOF: (1,2,3,4,5,6); color: WHITE; fixed_mesh}.

The Asset Library can contain a set of object classes for typical objects, such as chess pieces as above, or any other appropriate type of objects. The Asset Library can also contain a model of the robot body itself, which contains prior fixed parameters about the robot body, and also variable parameters such as actuatable member information, joint encoder positions, or any other appropriate variable information about the robot body. The Asset Library can also contain Fixed Asset objects that has no parameter member values. An example of a Fixed Asset is a table in front of the robot body; other examples could include the walls, floor, and other aspects of the environment that the robot should know, but there are no parameters to fill with sensory information. Aspects of the environment that are not changeable by the robot are generally suitable as fixed assets.

A Scene Graph generated by the foundational model can be a list of concrete instances of Asset Library objects and their parameters as perceived by the robot body based on sensor data (simulated or real). These include Fixed Assets, the robot body model, and the instances of concrete objects.

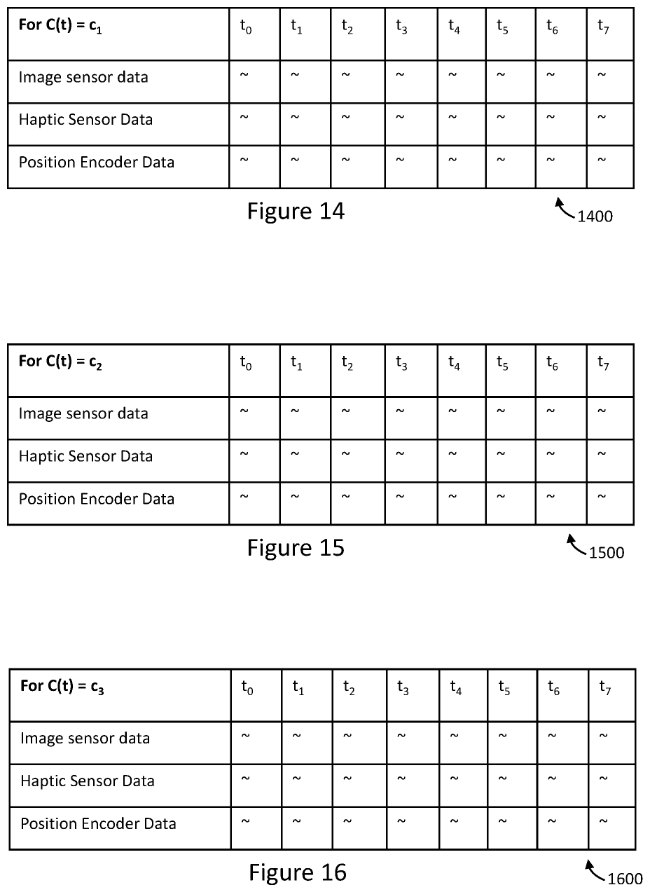

FIGS. 14, 15, and 16 discussed below illustrate an exemplary form of a state prediction model as discussed herein. FIGS. 14, 15, and 16 illustrate a plurality of matrices, where each matrix row represents data collected by a respective sensor, and each matrix column represents a respective time.

In matrix 1400 in FIG. 14, three sensor rows are shown, for a respective image sensor, haptic sensor, and position encoder. Many more types of sensor could be included (such as any sensors described herein), and a plurality of sensors of each type could be included. The example of FIG. 14 is merely illustrative, and thus complexity of matrix 1400 is limited for ease of discussion. Matrix 1400 is also illustrated as including times t₀, t₁, t₂, t₃, t₄, t₅, t₆, and t₇. Many more times can be included in a given matrix, and again the complexity of matrix 1400 is limited for ease of discussion. The plurality of times represents a sequence of time steps, as follows:

$${t}_{1} = {t}_{0} + {t}^{′}$$

$${t}_{2} = {t}_{1} + {t}^{″}$$

$${t}_{3} = {t}_{2} + {t}^{′′′}$$

$${t}_{4} = {t}_{3} + {t}^{′′′′}$$

$${t}_{5} = {t}_{4} + {t}^{′′′′′}$$

$${t}_{6} = {t}_{5} + {t}^{′′′′′′}$$

$${t}_{7} = {t}_{6} + {t}^{′′′′′′′}$$

Each of t′, t″, t′″, t″″, t′″″, t″″″, t′″″″ represents a respective time step. In some implementations, each time step is equal such that t′=t″=t′″=t″″=t′″″=t″″″=t′″″″. In other implementations, time steps are not necessarily equal. As mentioned earlier, time steps are preferably small (e.g. less than one second) to improve accuracy of the model. However, this is not necessarily the case, and time steps can be any length as appropriate for a given application.

To utilize the model as shown in FIG. 14 in the context of the methods herein, a first state is determined based on sensor data (environment data and robot body data), as described with reference to acts 408 in method 400 in FIG. 4, and in method 1200 in FIG. 12. Based on the sensor data, the first state is determined by selecting a column of matrix 1400 where the sensor data stored in the column matches (or at least approximates) the captured sensor data.

With the state determined, a subsequent state is predicted (as in acts 410 or 420 of method 400, or acts 1210 or 1230 in method 1200) as the state to the right of the determined state. That is, the state which is one time step in the future to the determined sate is predicted as the next state. This can also be applied to predict more states in the future, where each subsequent predicted state is one state to the right in the matrix from a previous state (whether predicted or actual).

In an exemplary scenario, a first state is determined as matching time t₃ in matrix 1400. A second state can then be predicted as corresponding to time t₄ in matrix 1400. A third state can then be predicted as corresponding to time t₅ in matrix 1400. A fourth state can then be predicted as corresponding to time t₆ in matrix 1400, and so on.

The above discussion of FIG. 14 assumes a context for operation of the robot body stays constant. In FIG. 14, the context is shown in the top-left corner of matrix 1400, with C(t)=c₁. That is, matrix 1400 illustrates sensor data over time for a context c₁. FIG. 15 illustrates matrix 1500 for context C(t)=c₂, and FIG. 16 illustrates matrix 1600 for context C(t)=c₃. With the exception of being to directed to different contexts of the robot body, FIGS. 15 and 16 are similar to FIG. 14, and description of FIG. 14 applies to FIGS. 15 and 16 unless context dictates otherwise, and is not repeated for brevity. Although three matrices for three contexts are illustrated, any number of matrices may be included to handle any number of contexts, as appropriate for a given application.

When context of the robot body changes (or is expected to change), the matrix for the appropriate context is accessed, and a state can be predicted by selecting a time in a column directly to the right of the present state (or other state on which the prediction is based).

The above discussion treats matrices 1400, 1500 and 1600 as separate matrices. However, a plurality of matrices can also be joined (or considered as joined) together as a three-dimensional matrix. In this way, states can be predicted through even changes in context. In an exemplary scenario, a first state is determined as matching time t₂ in matrix 1400. A second state is then predicted as corresponding to time t₃ in matrix 1400. At this point, an instruction which guides the robot may be completed (e.g. a task is complete), such that the context of the robot body also changes (e.g. to a new task). Based on this, a third state can then be predicted as corresponding to time t₄ in matrix 1500 for the next context. A fourth state can then be predicted as corresponding to time t₅ in matrix 1500, and so on.

The robot systems, methods, control modules, and computer program products described herein may, in some implementations, employ any of the teachings of U.S. Provisional Patent Application Ser. No. 63/450,460; U.S. patent application Ser. No. 18/375,943, U.S. patent application Ser. No. 18/513,440, U.S. patent application Ser. No. 18/417,081, U.S. patent application Ser. No. 18/424,551, U.S. patent application Ser. No. 16/940,566 (Publication No. US 2021-0031383 A1), U.S. patent application Ser. No. 17/023,929 (Publication No. US 2021-0090201 A1), U.S. patent application Ser. No. 17/061,187 (Publication No. US 2021-0122035 A1), U.S. patent application Ser. No. 17/098,716 (Publication No. US 2021-0146553 A1), U.S. patent application Ser. No. 17/111,789 (Publication No. US 2021-0170607 A1), U.S. patent application Ser. No. 17/158,244 (Publication No. US 2021-0234997 A1), U.S. Provisional Patent Application Ser. No. 63/001,755 (Publication No. US 2021-0307170 A1), and/or U.S. Provisional Patent Application Ser. No. 63/057,461, as well as U.S. Provisional Patent Application Ser. No. 63/151,044, U.S. Provisional Patent Application Ser. No. 63/173,670, U.S. Provisional Patent Application Ser. No. 63/184,268, U.S. Provisional Patent Application Ser. No. 63/213,385, U.S. Provisional Patent Application Ser. No. 63/232,694, U.S. Provisional Patent Application Ser. No. 63/316,693, U.S. Provisional Patent Application Ser. No. 63/253,591, U.S. Provisional Patent Application Ser. No. 63/293,968, U.S. Provisional Patent Application Ser. No. 63/293,973, and/or U.S. Provisional Patent Application Ser. No. 63/278,817, each of which is incorporated herein by reference in its entirety.

Throughout this specification and the appended claims the term “communicative” as in “communicative coupling” and in variants such as “communicatively coupled,” is generally used to refer to any engineered arrangement for transferring and/or exchanging information. For example, a communicative coupling may be achieved through a variety of different media and/or forms of communicative pathways, including without limitation: electrically conductive pathways (e.g., electrically conductive wires, electrically conductive traces), magnetic pathways (e.g., magnetic media), wireless signal transfer (e.g., radio frequency antennae), and/or optical pathways (e.g., optical fiber). Exemplary communicative couplings include, but are not limited to: electrical couplings, magnetic couplings, radio frequency couplings, and/or optical couplings.

Throughout this specification and the appended claims, infinitive verb forms are often used. Examples include, without limitation: “to encode,” “to provide,” “to store,” and the like. Unless the specific context requires otherwise, such infinitive verb forms are used in an open, inclusive sense, that is as “to, at least, encode,” “to, at least, provide,” “to, at least, store,” and so on.

This specification, including the drawings and the abstract, is not intended to be an exhaustive or limiting description of all implementations and embodiments of the present robots, robot systems and methods. A person of skill in the art will appreciate that the various descriptions and drawings provided may be modified without departing from the spirit and scope of the disclosure. In particular, the teachings herein are not intended to be limited by or to the illustrative examples of computer systems and computing environments provided.

This specification provides various implementations and embodiments in the form of block diagrams, schematics, flowcharts, and examples. A person skilled in the art will understand that any function and/or operation within such block diagrams, schematics, flowcharts, or examples can be implemented, individually and/or collectively, by a wide range of hardware, software, and/or firmware. For example, the various embodiments disclosed herein, in whole or in part, can be equivalently implemented in one or more: application-specific integrated circuit(s) (i.e., ASICs); standard integrated circuit(s); computer program(s) executed by any number of computers (e.g., program(s) running on any number of computer systems); program(s) executed by any number of controllers (e.g., microcontrollers); and/or program(s) executed by any number of processors (e.g., microprocessors, central processing units, graphical processing units), as well as in firmware, and in any combination of the foregoing.

Throughout this specification and the appended claims, a “memory” or “storage medium” is a processor-readable medium that is an electronic, magnetic, optical, electromagnetic, infrared, semiconductor, or other physical device or means that contains or stores processor data, data objects, logic, instructions, and/or programs. When data, data objects, logic, instructions, and/or programs are implemented as software and stored in a memory or storage medium, such can be stored in any suitable processor-readable medium for use by any suitable processor-related instruction execution system, apparatus, or device, such as a computer-based system, processor-containing system, or other system that can fetch the data, data objects, logic, instructions, and/or programs from the memory or storage medium and perform various acts or manipulations (i.e., processing steps) thereon and/or in response thereto. Thus, a “non-transitory processor-readable storage medium” can be any element that stores the data, data objects, logic, instructions, and/or programs for use by or in connection with the instruction execution system, apparatus, and/or device. As specific non-limiting examples, the processor-readable medium can be: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and/or any other non-transitory medium.

The claims of the disclosure are below. This disclosure is intended to support, enable, and illustrate the claims but is not intended to limit the scope of the claims to any specific implementations or embodiments. In general, the claims should be construed to include all possible implementations and embodiments along with the full scope of equivalents to which such claims are entitled.

1. A method for operating a robot system including a robot controller and a robot body, the method comprising:
capturing, by at least one environment sensor carried by the robot body, first environment data representing an environment of the robot body at a first time;
capturing, by at least one robot body sensor carried by the robot body, first robot body data representing a configuration of the robot body at the first time;
accessing, by the robot controller, context data indicating a context for operation of the robot system;
determining, by the robot controller, a first state of the robot body within the environment for the first time, based on the first environment data and the first robot body data;
applying, by the robot controller, a state prediction model to predict a predicted second state of the robot body within the environment for a second time subsequent the first time, wherein the state prediction model accounts for the first state of the robot body within the environment and the context for operation of the robot system as indicated in the context data; and
controlling, by the robot controller, the robot body to transition towards the predicted second state from the first state.

2. The method of claim 1, further comprising, at or after the second time:
capturing, by the at least one environment sensor, second environment data representing an environment of the robot body at the second time;
capturing, by the at least one robot body sensor, second robot body data representing a configuration of the robot body at the second time;
determining, by the robot controller, an actual second state of the robot body within the environment for the second time, based on the second environment data and the second robot body data; and
determining, by the robot controller, whether the actual second state matches the predicted second state of the robot body.

3. The method of claim 2, further comprising:
before the second time:
applying the state prediction model to predict a predicted third state of the robot body within the environment for a third time subsequent the second time, wherein the state prediction model accounts for the predicted second state of the robot body within the environment and the context for operation of the robot system as indicated in the context data; and
at or after the second time:
if the actual second state is determined as not matching the predicted second state, applying the state prediction model to update the predicted third state of the robot body within the environment for the third time subsequent the second time, wherein the state prediction model accounts for the actual second state of the robot body within the environment and the context for operation of the robot system as indicated in the context data; and
controlling the robot body to transition towards the predicted third state from the actual second state.

4. The method of claim 1, wherein applying the state prediction model to predict a predicted second state comprises:
applying the state prediction model to predict a sequence of states for the robot body within the environment for a sequence of times subsequent the first time, wherein the state prediction model accounts for the first state of the robot body within the environment and the context for operation of the robot system as indicated in the context data, and wherein each state in the sequence of states is predicted based on an immediately prior state in the sequence of states, and where the second state is predicted as one state in the sequence of states.

5. The method of claim 4, wherein controlling the robot body to transition towards the predicted second state from the first state comprises controlling the robot body to transition through the sequence of states including the second state, and wherein controlling the robot body to transition through the sequence of states comprises, for at least one state transitioned to:
capturing, by the at least one environment sensor, respective environment data representing an environment of the robot body at a respective time of the state transitioned to;
capturing, by the at least one robot body sensor, respective robot body data representing a configuration of the robot body at the respective time of the state transitioned to;
determining an actual state of the robot body within the environment for the respective time of the state transitioned to, based on the respective environment data and the respective robot body data; and
determining whether the actual state matches a predicted state of the robot body for the respective time of the state transitioned to, as predicted during the prediction of the sequence of states.

6. The method of claim 5, wherein controlling the robot body to transition through the sequence of states comprises, for the at least one state transitioned to:
if the actual state is determined to match a predicted state for the respective time of the state transitioned to: continue controlling the robot system to transition through the sequence of states; and
if the actual state is determined to not match a predicted state for the respective time of the state transitioned to:
apply the state prediction model to update the sequence of states of the robot body within the environment for an updated sequence of times subsequent the respective time of the state transitioned to, wherein the state prediction model accounts for the actual state of the robot body within the environment at the respective time and the context for operation of the robot system as indicated in the context data, and wherein each updated state in the sequence of states is predicted based on an immediately prior state in the sequence of states; and
controlling the robot body to transition through the updated sequence of states.

7. A robot system comprising:
a robot body;
at least one environment sensor carried by the robot body;
at least one robot body sensor carried by the robot body;
a robot controller which includes at least one processor and at least one non-transitory processor-readable storage medium communicatively coupled to the at least one processor, the at least one processor-readable storage medium storing processor-executable instructions which when executed by the at least one processor cause the robot system to:
capture, by the at least one environment sensor, first environment data representing an environment of the robot body at a first time;
capture, by the at least one robot body sensor, first robot body data representing a configuration of the robot body at the first time;
access context data indicating a context for operation of the robot system;
determine a first state of the robot body within the environment for the first time, based on the first environment data and the first robot body data;
apply a state prediction model to predict a predicted second state of the robot body within the environment for a second time subsequent the first time, wherein the state prediction model accounts for the first state of the robot body within the environment and the context for operation of the robot system as indicated in the context data; and
control the robot body to transition towards the predicted second state from the first state.

8. The robot system of claim 7, wherein the processor-executable instructions further cause the robot system to, at or after the second time:
capture, by the at least one environment sensor, second environment data representing an environment of the robot body at the second time;
capture, by the at least one robot body sensor, second robot body data representing a configuration of the robot body at the second time;
determine an actual second state of the robot body within the environment for the second time, based on the second environment data and the second robot body data; and
determine whether the actual second state matches the predicted second state of the robot body.

9. The robot system of claim 8, wherein the processor-executable instructions further cause the robot system to:
before the second time:
apply the state prediction model to predict a predicted third state of the robot body within the environment for a third time subsequent the second time, wherein the state prediction model accounts for the predicted second state of the robot body within the environment and the context for operation of the robot system as indicated in the context data; and
at or after the second time:
if the actual second state is determined as not matching the predicted second state, apply the state prediction model to update the predicted third state of the robot body within the environment for the third time subsequent the second time, wherein the state prediction model accounts for the actual second state of the robot body within the environment and the context for operation of the robot system as indicated in the context data; and
control the robot body to transition towards the predicted third state from the actual second state.

10. The robot system of claim 7, wherein the processor-executable instructions which cause the robot system to apply the state prediction model to predict a predicted second state cause the robot system to:
apply the state prediction model to predict a sequence of states for the robot body within the environment for a sequence of times subsequent the first time, wherein the state prediction model accounts for the first state of the robot body within the environment and the context for operation of the robot system as indicated in the context data, and wherein each state in the sequence of states is predicted based on an immediately prior state in the sequence of states, and where the second state is predicted as one state in the sequence of states.

11. The robot system of claim 10, wherein the processor-executable instructions which cause the robot system to control the robot body to transition towards the predicted second state from the first state cause the robot system to control the robot body to transition through the sequence of states including the second state, and wherein the processor-executable instructions which cause the robot system to control the robot body to transition through the sequence of states cause the robot system to, for at least one state transitioned to:
capture, by the at least one environment sensor, respective environment data representing an environment of the robot body at a respective time of the state transitioned to;
capture, by the at least one robot body sensor, respective robot body data representing a configuration of the robot body at the respective time of the state transitioned to;
determine an actual state of the robot body within the environment for the respective time of the state transitioned to, based on the respective environment data and the respective robot body data; and
determine whether the actual state matches a predicted state of the robot body for the respective time of the state transitioned to, as predicted during the prediction of the sequence of states.

12. The robot system of claim 11, wherein the processor-executable instructions which cause the robot system to control the robot body to transition through the sequence of states cause the robot system to, for the at least one state transitioned to:
if the actual state is determined to match a predicted state for the respective time of the state transitioned to: continue to control the robot system to transition through the sequence of states; and
if the actual state is determined to not match a predicted state for the respective time of the state transitioned to:
apply the state prediction model to update the sequence of states of the robot body within the environment for an updated sequence of times subsequent the respective time of the state transitioned to, wherein the state prediction model accounts for the actual state of the robot body within the environment at the respective time and the context for operation of the robot system as indicated in the context data, and wherein each updated state in the sequence of states is predicted based on an immediately prior state in the sequence of states; and
control the robot body to transition through the updated sequence of states.

13. The robot system of claim 7, wherein the at least one environment sensor includes one or more environment sensors selected from a group of sensors consisting of:
an image sensor operable to capture image data;
an audio sensor operable to capture audio data; and
a tactile sensor operable to capture tactile data.

14. The robot system of claim 7, wherein the at least one robot body sensor includes one or more robot body sensors selected from a group of sensors consisting of:
a haptic sensor which captures haptic data;
an actuator sensor which captures actuator data indicating a state of a corresponding actuator;
a battery sensor which captures battery data indicating a state of a battery;
an inertial sensor which captures inertial data;
a proprioceptive sensor which captures proprioceptive data indicating a position, movement, or force applied for a corresponding actuatable member of the robot body; and
a position encoder which captures position data about at least one joint or appendage of the robot body.

15. A robot control module comprising at least one non-transitory processor-readable storage medium storing processor-executable instructions or data that, when executed by at least one processor of a processor-based system, cause the processor-based system to:
capture, by at least one environment sensor carried by a robot body of the processor-based system, first environment data representing an environment of the robot body at a first time;
capture, by at least one robot body sensor carried by the robot body, first robot body data representing a configuration of the robot body at the first time;
access context data indicating a context for operation of the processor-based system;
determine a first state of the robot body within the environment for the first time, based on the first environment data and the first robot body data;
apply a state prediction model to predict a predicted second state of the robot body within the environment for a second time subsequent the first time, wherein the state prediction model accounts for the first state of the robot body within the environment and the context for operation of the robot system as indicated in the context data; and
control the robot body to transition towards the predicted second state from the first state.

16. The robot control module of claim 15, wherein the processor-executable instructions further cause the processor-based system to, at or after the second time:
capture, by the at least one environment sensor, second environment data representing an environment of the robot body at the second time;
capture, by the at least one robot body sensor, second robot body data representing a configuration of the robot body at the second time;
determine an actual second state of the robot body within the environment for the second time, based on the second environment data and the second robot body data; and
determine whether the actual second state matches the predicted second state of the robot body.

17. The robot control module of claim 16, wherein the processor-executable instructions further cause the processor-based system to:
before the second time:
apply the state prediction model to predict a predicted third state of the robot body within the environment for a third time subsequent the second time, wherein the state prediction model accounts for the predicted second state of the robot body within the environment and the context for operation of the robot system as indicated in the context data; and
at or after the second time:
if the actual second state is determined as not matching the predicted second state, apply the state prediction model to update the predicted third state of the robot body within the environment for the third time subsequent the second time, wherein the state prediction model accounts for the actual second state of the robot body within the environment and the context for operation of the robot system as indicated in the context data; and
control the robot body to transition towards the predicted third state from the actual second state.

18. The robot control module of claim 15, wherein the processor-executable instructions which cause the processor-based system to apply the state prediction model to predict a predicted second state cause the processor-based system to:
apply the state prediction model to predict a sequence of states for the robot body within the environment for a sequence of times subsequent the first time, wherein the state prediction model accounts for the first state of the robot body within the environment and the context for operation of the processor-based system as indicated in the context data, and wherein each state in the sequence of states is predicted based on an immediately prior state in the sequence of states, and where the second state is predicted as one state in the sequence of states.

19. The robot control module of claim 18, wherein the processor-executable instructions which cause the processor-based system to control the robot body to transition towards the predicted second state from the first state cause the processor-based system to control the robot body to transition through the sequence of states including the second state, and wherein the processor-executable instructions which cause the processor-based system to control the robot body to transition through the sequence of states cause the processor-based system to, for at least one state transitioned to:
capture, by the at least one environment sensor, respective environment data representing an environment of the robot body at a respective time of the state transitioned to;
capture, by the at least one robot body sensor, respective robot body data representing a configuration of the robot body at the respective time of the state transitioned to;
determine an actual state of the robot body within the environment for the respective time of the state transitioned to, based on the respective environment data and the respective robot body data; and
determine whether the actual state matches a predicted state of the robot body for the respective time of the state transitioned to, as predicted during the prediction of the sequence of states.

20. The robot control module of claim 19, wherein the processor-executable instructions which cause the processor-based system to control the robot body to transition through the sequence of states cause the processor-based system to, for the at least one state transitioned to:
if the actual state is determined to match a predicted state for the respective time of the state transitioned to: continue to control the processor-based system to transition through the sequence of states; and
if the actual state is determined to not match a predicted state for the respective time of the state transitioned to:
apply the state prediction model to update the sequence of states of the robot body within the environment for an updated sequence of times subsequent the respective time of the state transitioned to, wherein the state prediction model accounts for the actual state of the robot body within the environment at the respective time and the context for operation of the processor-based system as indicated in the context data, and wherein each updated state in the sequence of states is predicted based on an immediately prior state in the sequence of states; and
control the robot body to transition through the updated sequence of states.
